(19) United States
(12) Patent Application Publication
(10) Pub. No.: US 2007/0281666 A1
(43) Pub. Date: Dec. 6, 2007

(54) INFORMATION PROCESSING APPARATUS

(75) Inventor: Katsuhiko Yoshida, Hachioji-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/461,884

(22) Filed: Aug. 2, 2006

(30) Foreign Application Priority Data
Jun. 5, 2006 (JP) 2006-156147

(51) Int. Cl. H04M 1/66

(52) U.S. Cl. 455/411

(57) ABSTRACT

In an information processing apparatus, a state determining unit determines a current state of a digital cellular phone with a camera based on a detection signal output from magnetic sensors and generates a state detection instruction signal indicating the state detection result. A switching control unit generates a switching control signal for controlling the switching to an input screen for inputting a lock number and/or lock rhythm pattern for locking or unlocking and supplies the generated switching control signal to an LCD control portion.

### CROSS REFERENCE TO RELATED APPLICATION

This application is based upon and claims the benefit of priority from prior Japanese Patent Application No. 2006-156147 filed on Jun. 5, 2006, the entire contents of which are incorporated herein by reference.

### BACKGROUND OF THE INVENTION

1. Field of the Invention

The present invention relates to an information processing apparatus and, in particular to an information processing apparatus including a lock function.

2. Related Art

In recent years, a cellular phone functioning as an information processing apparatus has various functions including not only a simply communication function by talking but also a directory function, a mail function over a network such as the Internet, and a browser function allowing to view a Web page, for example.

For these functions, a cellular phone can store various kinds of data relating to a user thereof and may have a lock function increasingly. The lock function may allow locking the cellular phone (by security lock or automatic lock, for example) in advance so as to protect data as described above from viewing and/or using illegally by other people. When a cellular phone is locked by the lock function, a key operation on the cellular phone is invalid unless the cellular phone is unlocked.

A cellular phone having a lock function has been proposed which performs authentication by using a lock number (such as a so-called PIN number and a password) and/or a lock rhythm pattern.

A cellular phone has been further proposed which has another lock function performing the authentication of a valid user by using an image shot by a shooting portion such as a CCD camera.

A cellular phone has been further proposed which has another lock function performing authentication by using both lock number and lock rhythm pattern such as shown in Japanese Unexamined Patent Application Publication No. 2000-259568 (Patent Document 1), for example.

The cellular phone proposed in the above Patent Document 1 can improve the security performance by determining the agreement of a key-input lock number (or PIN code) and monitoring the timing of key-inputting of an input lock number by a user.

In recent years, various cellular phone styles have been proposed such as a straight style, a flip style, a fold-in-two style, a biaxial-rotation style, a slide style and a slide-and-rotate style.

The biaxial-rotation style cellular phone, for example, has an advantage that the main display screen of a liquid crystal display is visible to a user not only with the cellular phone opened but also folded.

In order to use a lock number for locking or unlocking the biaxial-rotation style cellular phone, like the other style cellular phones, inputting a lock number by using a numeral key is required for locking or unlocking. However, with the biaxial-rotation style cellular phone folded, numeral keys are covered by the cabinet of the cellular phone, preventing the operation of the numeral key as it is. Therefore, a user has to take time for changing the folded state to the normal open style for inputting a lock number to operate the numeral keys. The operation is significantly troublesome to a user.

### SUMMARY OF THE INVENTION

Accordingly, the present invention was conceived in consideration of the above circumstances, and it is an object of the present invention to provide an information processing apparatus that allows easy switching to the input screen for authentication information for locking or unlocking.

The above and other objects can be achieved according to the present invention by providing, in one aspect, an information processing apparatus comprising:

a memory unit configured to store multiple pieces of authentication information;

an authenticating unit configured to authenticate by using one of the multiple pieces of authentication information stored in the memory unit;

a first control unit configured to control performance of locking or unlocking operation;

a state detecting unit configured to detect a state of the information processing apparatus; and

a second control unit configured to control switching to a screen for inputting the authentication information in accordance with the state detection result detected by the state detecting unit.

There is also provided, in another aspect of the present invention, an information processing apparatus comprising:

a memory unit configured to store multiple pieces of authentication information;

an authenticating unit configured to authenticate by using one of the multiple pieces of authentication information stored by the memory unit;

a first control unit configured to control performance of locking or unlocking operation;

a key determining unit configured to determine whether a predetermined key in the information processing apparatus has been pressed or not; and

a second control unit configured to control the switching to a screen for inputting the authentication information when the key determining unit determines that a predetermined key in the information processing apparatus has been pressed.

In a further aspect of the present invention, there is also provided an information processing apparatus comprising:

a memory unit configured to store multiple pieces of authentication information;

an inputting unit including at least an operation key for inputting the information;

a control unit configured to control performance of locking or unlocking operation;

a state detecting unit configured to detect whether a state of the information processing apparatus is in a first state in which the key is in an operative state and in a second state in which the key is in an inoperative state; and

an authenticating unit configured to authenticate by using one of the multiple pieces of authentication information stored in the memory unit, wherein when the information processing apparatus is in the second state detected by the state detecting unit, the authentication is effected in accordance with information input by an input element other than the above-mentioned operation key.

In an information processing apparatus according to the invention, the state of the information processing apparatus may be detected, and the switching to an authentication information input screen for inputting authentication information may be controlled in accordance with the detected state detection result.

In an information processing apparatus according to the invention, whether a predetermined key in the information processing apparatus has been pressed or not is determined, and the switching to a screen for inputting authentication information may be controlled when it is determined that the predetermined key in the information processing apparatus has been pressed.

According to the present invention of the characters mentioned above, input screens for authentication information can be easily switched for locking or unlocking.

The nature and further characteristic features of the present invention will be made clearer from the following descriptions made with reference to the accompanying drawings.

### BRIEF DESCRIPTION OF THE DRAWINGS

In the accompanying drawings:

FIGS. 1A and 1B are diagrams showing external front and elevation constructions of a cellular phone with a digital camera, which is applicable as an information processing apparatus according to the present invention, opened at about 180 degrees;

FIGS. 2A and 2B are diagrams showing external front and elevation constructions of a closed cellular phone with a digital camera, which is applicable as an information processing apparatus according to the present invention;

FIGS. 3A and 3B are diagrams showing other external constructions of a cellular phone with a digital camera, which is applicable as an information processing apparatus according to the present invention;

FIGS. 4A and 4B are diagrams showing other external constructions of a cellular phone with a digital camera, which is applicable as an information processing apparatus according to the present invention;

FIGS. 5A and 5B are diagrams showing other external constructions of a cellular phone with a digital camera, which is applicable as an information processing apparatus according to the present invention;

FIG. 6 is a block diagram showing an internal construction of the cellular phone with a digital camera;

FIG. 7 is a block diagram showing a mechanical construction, which can be implemented in the cellular phone with a digital camera in FIG. 6;

FIG. 8 is a flowchart describing a lock number/lock rhythm pattern storage processing in the cellular phone with a digital camera in FIG. 7;

FIG. 9 is a diagram showing a display example of a lock number input screen to be displayed on the liquid crystal display in FIG. 6;

FIG. 10 is a diagram showing a display example of a lock rhythm pattern to be displayed on the liquid crystal display in FIG. 6;

FIG. 11 is a diagram showing a timing chart of a registered candidate lock rhythm obtained from an input registered candidate lock rhythm pattern;

FIG. 12 is a flowchart describing automatic lock setting processing in the cellular phone with a digital camera in FIG. 7;

FIG. 13 is a diagram showing transition of display screens to be displayed on the liquid crystal display in FIG. 6;

FIG. 14 is a diagram showing transition of display screens to be displayed on the liquid crystal display in FIG. 6;

FIG. 15 is a flowchart describing processing of canceling the automatic lock temporarily in the cellular phone with a digital camera in FIG. 7;

FIG. 16 is a diagram showing transition of display screens to be displayed on the liquid crystal display in FIG. 6; and

FIG. 17 is a flowchart describing processing of controlling the switching among authentication information input screens in the cellular phone with a digital camera in FIG. 7.

### DESCRIPTION OF THE PREFERRED EMBODIMENTS

Embodiments of the present invention will be described hereunder with reference to drawings. Further, it is first to be noted that terms “right”, “left”, “upper”, “lower” and the like terms are used herein with reference to the illustrated state in the drawings or actually using state of a cellular phone.

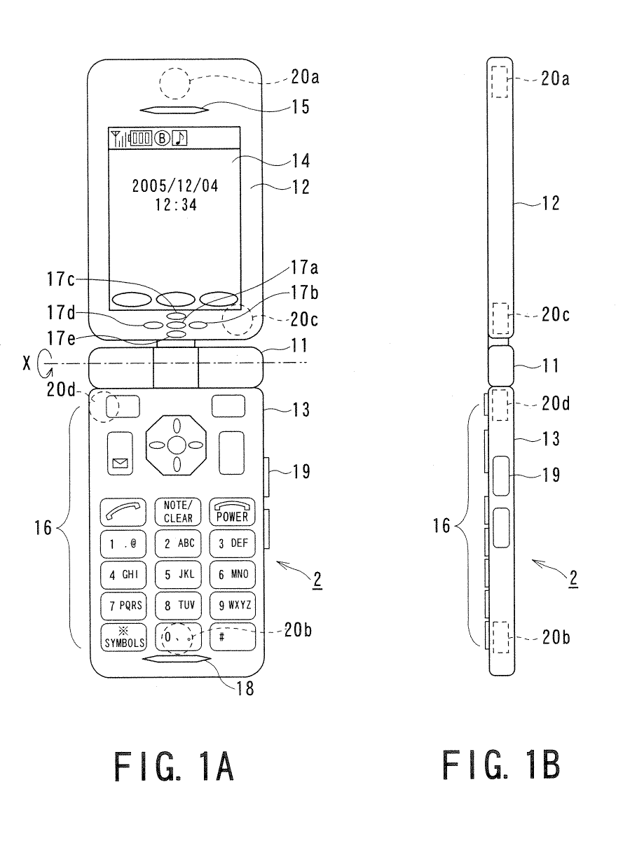

FIGS. 1A and 1B show external constructions of a digital cellular phone 2 with a camera (which will be simply called digital cellular phone 2 hereinafter), which is applicable to an information processing apparatus according to the invention. FIGS. 1A and 1B are diagrams showing external front and elevation constructions, respectively, of the digital cellular phone 2. The state that the digital cellular phone 2 is tilted to about 180 degrees, so-called open style, is called “first state” herein.

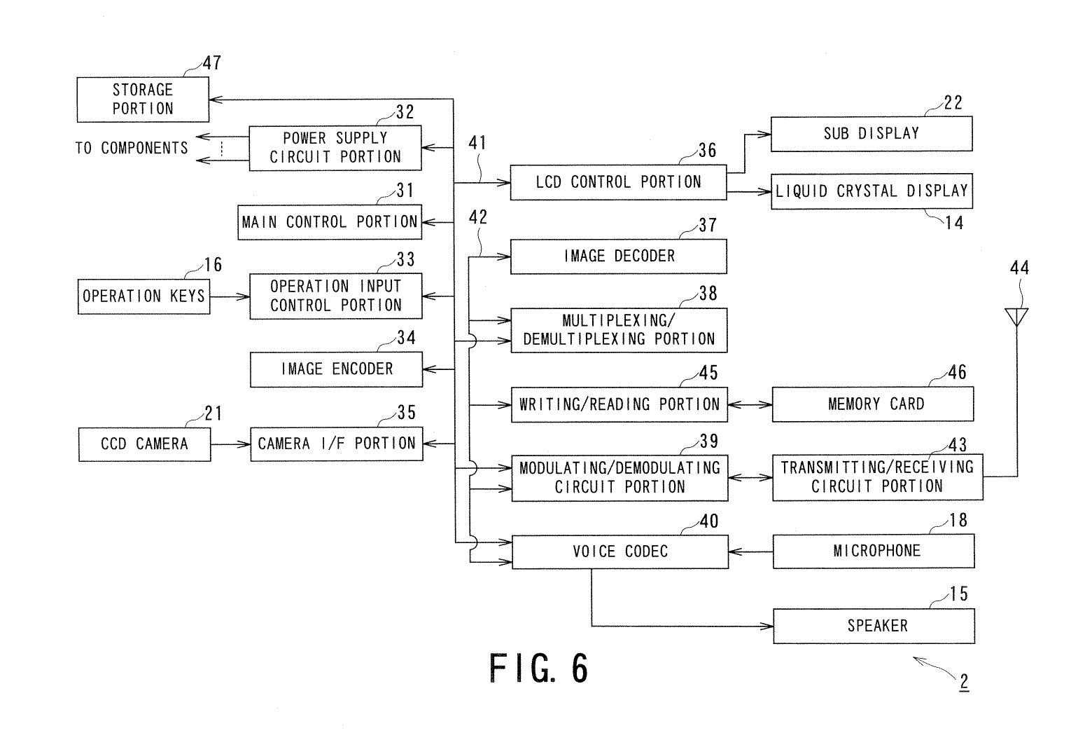

As shown in FIGS. 1A and 1B, the digital cellular phone 2 includes a first cabinet 12 and a second cabinet 13 with a hinge part 11 at the center and is foldable in the direction X about the hinge part 11. An antenna (that is, an antenna 44 in FIG. 6, which will be described later) for transmitting/receiving is provided at a predetermined position within the digital cellular phone 2 and exchanges radio waves with a base station, not shown, through the contained antenna.

The first cabinet 12 has a liquid crystal display 14 as a main display on the front side in the open state. The liquid crystal display 14 may display a receiving state of radio waves, a remaining amount of the battery, names and telephone numbers of receivers, which are registered in a telephone directory, a history of transmission, contents of electronic mails, simple websites, images shot by a CCD camera (that is, a CCD camera 21 in FIG. 1, which will be described later), contents received from an external contents server, not shown, and contents stored in a memory card (that is, memory card 46 in FIG. 6, which will be described later). A speaker 15 is further provided at a predetermined position above the liquid crystal display 14, allowing a user to call by voice.

On the other hand, the second cabinet 13 has operation keys 16 on the front surface, such as numeral keys from “0” to “9”, a call key, a re-dial key, a hang-up/power key, a clear key and an electronic mail key, and instructions can be input through the operation keys 16.

The second cabinet 13 also has a cross key and a confirmation key of the operation keys 16 in the upper part. A user manipulates the cross key vertically and/or horizontally to move a tapped cursor vertically and/or horizontally. More specifically, various operations may be performed thereby, such as a scrolling operation for a telephone directory list or an electronic mail, which is displayed on the liquid crystal display 14, a page-turning operation for a simple web-site and a forwarding operation on an image.

The confirmation key may be pressed to confirm various functions. For example, when a desired telephone number is selected from multiple telephone numbers in a telephone directory displayed on the liquid crystal display 14 in accordance with the manipulation on the cross key by a user, and the confirmation key is then pressed toward the inside of the second cabinet 13, the selected telephone number is confirmed, and calling processing is performed on the telephone number. The first cabinet 12 has operation keys 17a to 17e in the lower part, which correspond to the cross key and confirmation key on the second cabinet 13.

The second cabinet 13 further has an electronic mail key adjacent to the cross key and confirmation key on the left. When the electronic mail key is pressed toward the inside of the second cabinet 13, a mail transmitting/receiving function may be invoked. A browser key is provided adjacent to the cross key and confirmation key on the right. When the browser key is pressed toward the inside of the second cabinet 13, data on a Web page can be viewed. The electronic mail key and browser key adjacent to the cross and confirmation keys on the left and right are called “soft-1 key” and “soft-2 key”, respectively, since various functions such as “Yes” and “No” are provided thereto in accordance with the screen displayed on the liquid crystal display 14.

The second cabinet 13 further has a microphone 18 below the operation keys 16. The microphone 18 is used to gather voice of a user in talking. The second cabinet 13 further has a side key 19 for manipulating the digital cellular phone 2.

A battery pack, not shown, is attached to the back side of the second cabinet 13. When the hang-up/power key is turned on, power is supplied from the battery pack to circuit portions to start an operable mode.

By the way, the second cabinet 13 has a memory card slot, not shown, for attaching a removable memory card (such as a memory card 46 in FIG. 6, which will be described later) therethrough at a predetermined position in the lower part of the second cabinet 13. When a note button, not shown, is pressed, the memory card may record the voice of the other talking party, and, in accordance with an operation by a user, may record an electronic mail, a simple website and an image shot by the CCD camera.

Here, the memory card is a kind of flash memory card such as NAND type flash memory card and a NOR flash memory card and accommodates a flash memory element of a non-volatile memory in which data can be electrically overwritten or erased within a compact and thin plastic case. Various data such as images, voice and music can be written/read out thereto/therefrom through a 10-pin terminal.

The memory card adopts a unique serial protocol, which allows the compatibility with used equipment against changes in specifications of the contained flash memory such as an increase in capacity. Thus, the memory card can be operated in a higher speed and has higher reliability with a switch for preventing improper erasing.

Thus, the digital cellular phone 2 to which the memory card is attachable can share data with other electronic equipment through the memory card.

Magnetic sensors 20a, 20b, 20c and 20d for detecting states of the digital cellular phone 2 are provided at predetermined positions within the first cabinet 12 and second cabinet 13.

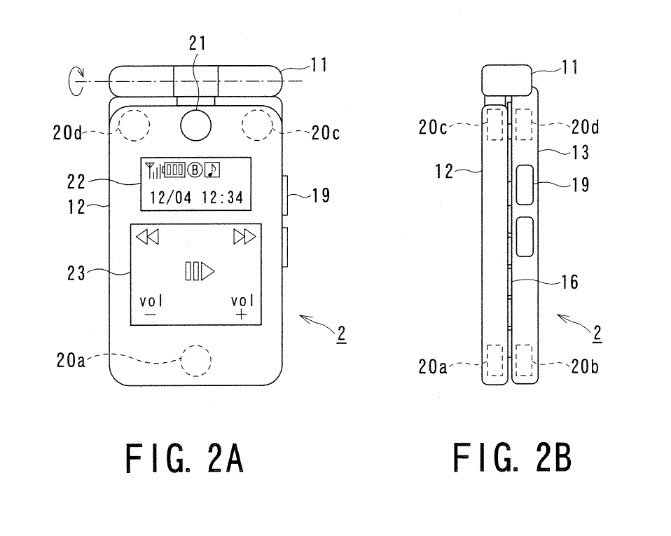

FIGS. 2A and 2B are other external constructions of the digital cellular phone 2, which is applicable as an information processing apparatus according to the present invention. FIGS. 2A and 2B show the state of the digital cellular phone 2 after the rotation of the digital cellular phone 2 in FIGS. 1A and 1B in the direction X. FIG. 2A shows an external front construction of the closed digital cellular phone 2. FIG. 2B shows an external elevation construction of the closed digital cellular phone 2. The state of the digital cellular phone 2 in FIGS. 2A and 2B is called “second state”.

A CCD camera 21 is provided in the upper part of the first cabinet 12 to shoot a desired subject. A sub-display 22 is provided below the CCD camera 21 to display an antenna pict for indicating the current level of the sensitivity of the antenna, a battery pict for indicating the current remaining amount of the battery of the digital cellular phone 2, the current time and so on.

An electrostatic touch pad 23 is provided below the sub-display 22. The electrostatic touch pad 23 appears as one touch panel but has sensors, not shown, at multiple points therein. When a user touches near one of the sensors, the sensor detects it and performs an operation such as a rewinding function, a forward function, a sound-level decreasing operation, a sound-level increasing operation, a play operation and a temporary stop operation.

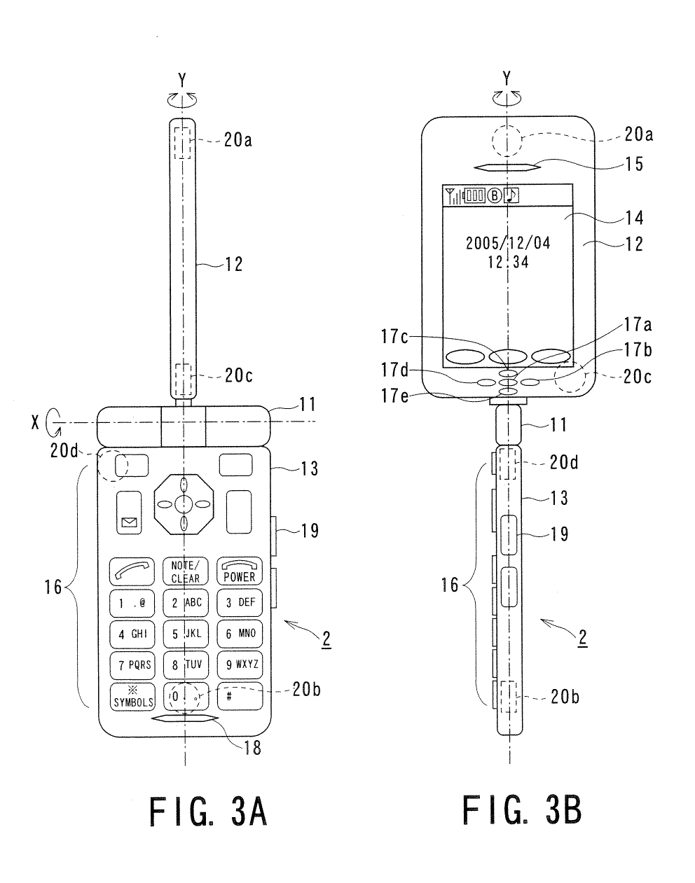

FIGS. 3A and 3B show other external constructions of the digital cellular phone 2, which is applicable as an information processing apparatus according to the present invention.

FIGS. 3A and 3B shows the state of the digital cellular phone 2 after the pivot of the digital cellular phone 2 in FIGS. 1A and 1B by 90 degrees in the direction Y. The state of the digital cellular phone 2 in FIGS. 3A and 3B is called “third state”. FIG. 3A shows an external front construction of the digital cellular phone 2 at the third state. FIG. 3B shows an external elevation construction of the digital cellular phone 2 at the third state.

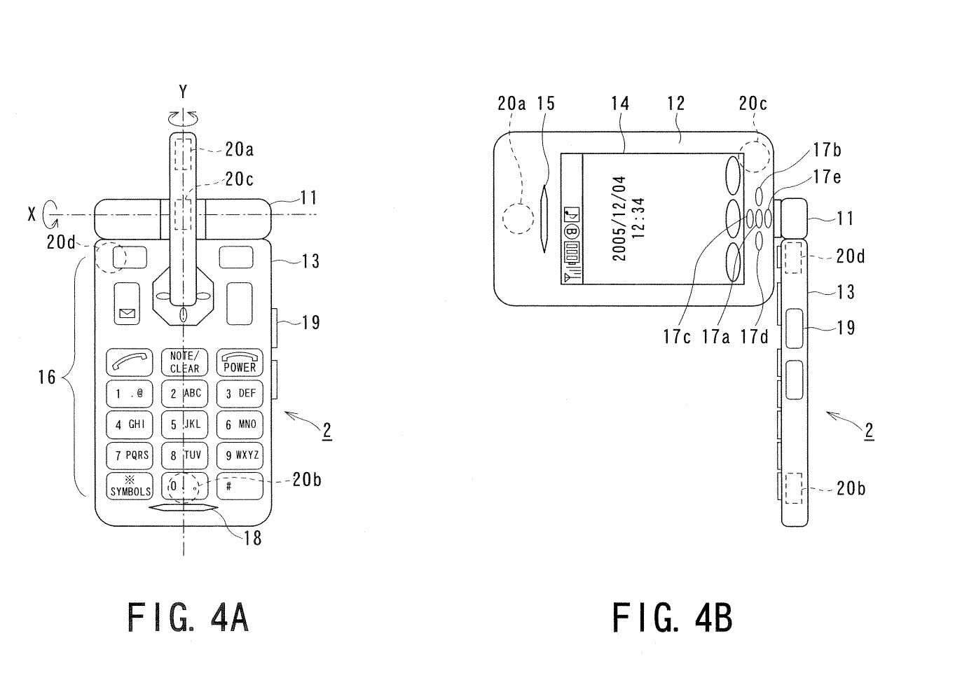

FIGS. 4A and 4B show other external constructions of the digital cellular phone 2, which is applicable as an information processing apparatus according to the present invention.

FIGS. 4A and 4B show the state of the digital cellular phone 2 after the rotation and bending of the digital cellular phone 2 in FIGS. 3A and 3B by 90 degrees in the direction X. The state of the digital cellular phone 2 in FIGS. 4A and 4B is called “fourth state”. FIG. 4A shows an external front construction of the digital cellular phone 2 at the fourth state. FIG. 4B shows an external elevation construction of the digital cellular phone 2 at the fourth state.

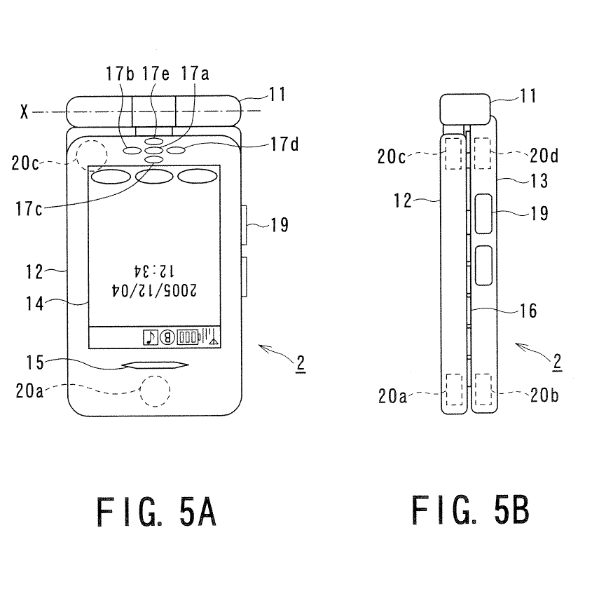

FIGS. 5A and 5B show other external constructions of the digital cellular phone 2, which is applicable as an information processing apparatus according to the present invention.

FIGS. 5A and 5B show the state of the digital cellular phone 2 in which the first cabinet 12 and the second cabinet 13 overlap one another with the liquid crystal display 14 outward, after the pivot by 90 degrees in the direction Y and rotation in the direction X of the digital cellular phone 2 in FIGS. 4A and 4B. The state, so called turnover style, of the digital cellular phone 2 in FIGS. 5A and 5B is called “fifth state”. FIG. 5A shows an external front construction of the digital cellular phone 2 at the fifth state. FIG. 5B shows an external elevation construction of the digital cellular phone 2 at the fifth state. As shown in FIGS. 1A to 5B, the digital cellular phone 2, which can rotate about orthogonal two axes, is called a biaxial rotation style digital cellular phone with a digital camera.

Here, a method for determining the state of the digital cellular phone 2 by using the magnetic sensors 20a to 20d will be described in which the magnetic sensor 20a to 20d are provided at predetermined positions in the digital cellular phone 2.

The digital cellular phone 2 can have five states of the first to fifth state shown in FIGS. 1A to 5B. When sensors of the magnetic sensors 20a to 20d at predetermined positions in the digital cellular phone 2 are brought closer within a predetermined distance, the sensors generate a detection signal and output the detection signal to a main control portion 31, which will be described later with reference to FIG. 6.

For example, a pair of the magnetic sensor 20a and magnetic sensor 20b is used for determining either second state in FIGS. 2A and 2B or fifth state in FIGS. 5A and 5B or one of the other states of the first state in FIGS. 1A and 1B, the third state in FIGS. 3A and 3B and the fourth state in FIGS. 4A and 4B. A pair of the magnetic sensor 20c and the magnetic sensor 20d is used for determining either second state in FIGS. 2A and 2B or fifth state in FIGS. 5A and 5B. Thus, the current state of the digital cellular phone 2 can be detected.

FIG. 6 shows an internal construction of the digital cellular phone 2, which is applicable as an information processing apparatus according to the present invention.

In the digital cellular phone 2, as shown in FIG. 6, a main control portion 31 centrally controlling the components in the first cabinet 12 and second cabinet 13 is connected, through a synchronous bus 42, to a power supply circuit portion 32, an operation input control portion 33, an image encoder 34, a camera interface portion 35, an LCD control portion (first control unit) 36, a multiplexing/demultiplexing portion 38, a modulating/demodulating circuit portion 39, a voice codec 40 and a memory (storage) portion 47 through a main bus 41 and to an image encoder 34, an image decoder 37, a multiplexing/demultiplexing portion 38, a modulating/demodulating circuit portion 39, a voice codec 40 and writing/reading portion 45.

The power supply circuit 32 starts the digital cellular phone 2 into the operable state by supplying power from the battery pack to the components when the hang-up/power key is turned on in response to an operation by a user.

The main control portion 31 includes a CPU, a ROM and a RAM. The CPU performs processing in accordance with a program stored in the ROM or an application program loaded from the memory portion 47 to the RAM, generates and outputs a control signal to a component in order to centrally control the digital cellular phone 2. The RAM stores data required by the CPU for performing processing.

The main control portion 31 internally contains a timer for accurately measuring the current date and time.

Here, the application program to be executed by the CPU can be installed in the ROM or memory portion 47 in advance. An application program to be executed by the CPU may be installed in the memory portion 47 by downloading it to the digital cellular phone 2 by the communication through a base station, not shown. The application program to be executed by the CPU can be further recorded in the memory card 46, read out by the writing/reading portion 45 and installed in the memory portion 47.

The digital cellular phone 2 converts and compresses voice signals gathered by the microphone 18 in voice talking mode to digital voice signals by using the voice codec 40 under the control of the main control portion 31, performs spectrum despread processing thereon by the modulating/demodulating circuit portion 39, performs digital/analog converting processing and frequency converting processing thereon in the transmitting/receiving circuit 43 and then transmits it through the antenna 44.

The digital cellular phone 2 amplifies a signal received by the antenna 44 in the voice talking mode, performs frequency converting processing and analog/digital converting processing thereon, performs despread processing thereon by the modulating/demodulating circuit portion 39, expands it by the voice codec 40, converts it to an analog voice signal and outputs the converted analog voice signal through a speaker 15.

In order to transmit an electronic mail in a data communication mode, the digital cellular phone 2 transmits text data of the electronic mail input by an operation on the operation keys 16 to the main control portion 31 through the operation input control portion 33. The main control portion 31 performs spectrum spread processing on the text data in the modulating/demodulating circuit portion 39, performs digital/analog converting processing and frequency converting processing thereon in a transmitting/receiving circuit portion 43 and transmits the result to a base station, not shown, through an antenna 44.

On the other hand, when an electronic mail is received in the data communication mode, the digital cellular phone 2 performs, in the modulating/demodulating circuit 39, spectrum despread processing on the signal received from a base station, not shown, through the antenna 44 to reconstruct the original text data and displays it as an electronic mail on the liquid crystal display 14 through an LCD control portion 36.

Then, the digital cellular phone 2 can record an electronic mail received in accordance with the operation by the user in the memory card 46 through the writing/reading portion 45.

If an image signal is not transmitted, the digital cellular phone 2 directly displays an image signal shot by the CCD camera 21 on the liquid crystal display 14 through the camera interface portion 35 and LCD control portion 36.

In order to transmit an image signal in the data communication mode, the digital cellular phone 2 supplies an image signal shot by the CCD camera 21 to the image encoder 34 through the camera interface portion 35.

The image encoder 34 converts the image signal supplied from the CCD camera 31 to an encoded image signal by compressing and encoding the image signal by a predetermined encoding scheme such as MPEG4 and transmits the converted encoded image signal to the multiplexing/demultiplexing portion 38. At the same time, the digital cellular phone 2 transmits the voice gathered by the microphone 18 during shooting by the CCD camera 21 to the multiplexing/demultiplexing portion 38 through the voice codec 40 as digital voice signals.

The multiplexing/demultiplexing portion 38 multiplexes the encoded image signal supplied from the image encoder 34 and the voice signal supplied from the voice codec 40 by a predetermined scheme, performs spectrum spread processing on the resulting multiplexed signal in the modulating/demodulating circuit portion 39, performs digital/analog converting processing and frequency converting processing thereon in the transmitting/receiving circuit portion 43 and transmits the result through the antenna 44.

On the other hand, the digital cellular phone 2 can receive data on a Web page in the data communication mode.

In other words, when the digital cellular phone 2 transmits data requesting a Web page, for example in the data communication mode, the data on the Web page is transmitted through a base station, not shown, in accordance with the request, the data on the Web pages received by the transmitting/receiving circuit portion 43 and modulating/demodulating circuit 39 through the antenna 44. The transmitting/receiving circuit portion 43 and modulating/demodulating circuit 39 transmits the received data on the Web page to the main control portion 31.

The main control portion 31 interprets the data on the Web page and creates a screen (an image) based on the interpretation. The created screen is supplied to and displayed on the liquid crystal display 14 from the main control portion 31 through the LCD control portion 36. In other words, a Web browser application program is at least installed in the ROM or memory portion 47 of the main control portion 31. The CPU of the main control portion 31 executes the Web browser application program on the RAM to function as a Web browser and interprets the data on a Web page.

In order to receive data on a moving picture file linked to a Web page, for example, in the data communication mode, the digital cellular phone 2 performs spectrum despread processing in the modulating/demodulating circuit portion 39 on the signal received from a base station, not shown, through the antenna 44 and transmits the resulting multiplexed signal to the demultiplexing potion 38.

The multiplexing/demultiplexing portion 38 demultiplexes the multiplexed signal into an encoded image signal and voice signal and supplies the encoded image signal to the image decoder 37 and voice signal to the voice codec 40 through the synchronous bus 42. The image decoder 37 decodes the encoded image signal by a decoding scheme corresponding to a predetermined encoding scheme such as MPEG4 to generate a reproduced moving picture signal, and supplies the generated reproduced moving picture image to the liquid crystal display 14 through the LCD control portion 36. Thus, the moving picture data included in the moving picture file linked to a Web page, for example, is displayed therein.

At the same time, the voice codec 40 converts the voice signal to an analog voice signal and then supplies it to the speaker 15. Thus, the voice signal included in the moving image file linked to a Web page, for example, is reproduced. Like the electronic mail case, the digital cellular phone 2 can record the data linked to a received Web page, for example, in the memory card 46 through the writing/reading portion 45 in response to an operation by a user.

The memory portion 47 includes a flash memory element, which is a kind of EEPROM being an electrically overwritable and erasable non-volatile memory and stores an application programs and data piece to be executed by the CPU of the main control portion 31. The memory portion 47 stores, as required, an electronic mail received in response to an operation by a user and/or moving picture data included in a moving picture file linked to a received Web page, for example.

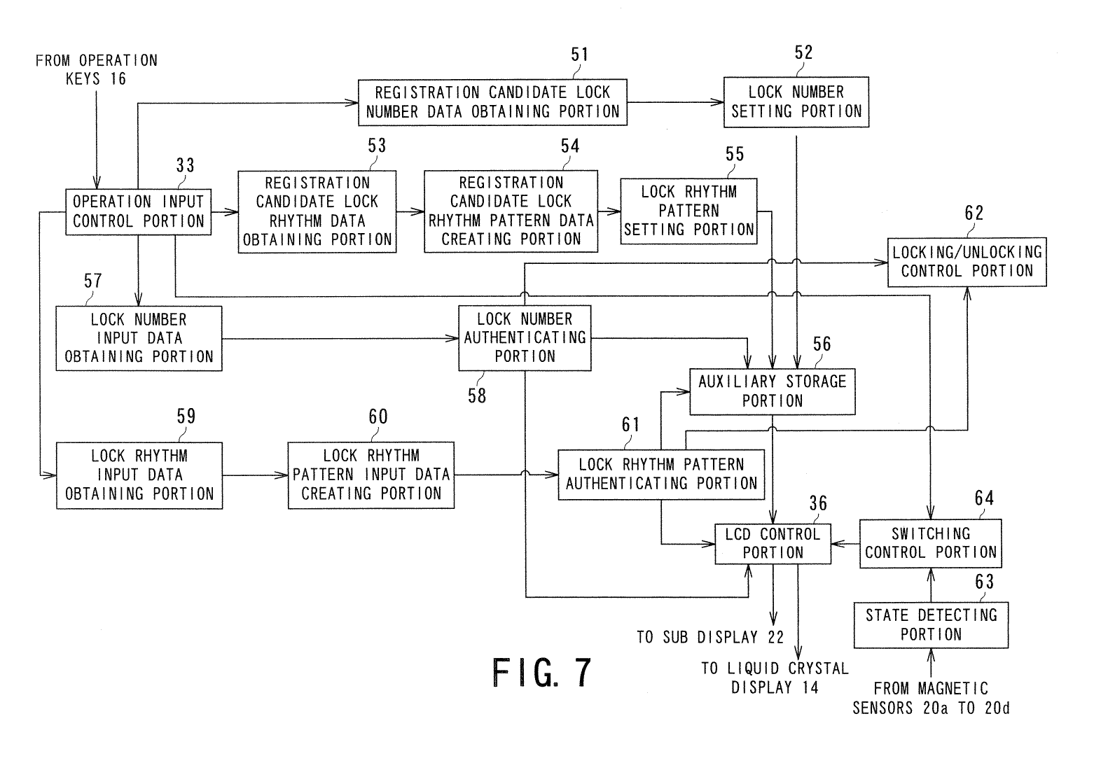

FIG. 7 shows a mechanical construction executable by the digital cellular phone 2 in FIG. 6. The same reference numerals are given to the same components as those in FIG. 6.

The operation input control portion 33 obtains data pieces input by a user by operating the operation keys 16 and supplies the obtained data to a component of the digital cellular phone 2.

The LCD control portion 36 obtains data from a component of the digital cellular phone 2 and causes the liquid crystal display 14 or sub-display 22 to display a message dialog or an unlocking screen, for example, based on the obtained data.

A registration candidate lock number data obtaining portion 51 obtains, through the operation input control portion 33, a lock number data being a candidate for registration (which will be called registration candidate lock number data, hereinafter) input by a user by operating the operation keys 16 and supplies the obtained registration candidate lock number data to a lock number setting portion 52.

The lock number setting portion 52 obtains the registration candidate lock number data supplied from the registration candidate lock number data obtaining portion 51, defines a lock number for locking or unlocking based on the obtained registration candidate lock number data and supplies the lock number data, which is data on the defined lock number to an auxiliary memory portion 56.

A registration candidate lock rhythm data obtaining portion 53 obtains, through the operation input control portion 33, lock rhythm data being a candidate for registration (which will be called registration candidate lock rhythm data, hereinafter) input by a user by operating the operation keys 16 and supplies the obtained registration candidate lock rhythm data to a registration candidate lock rhythm pattern data creating portion 54.

The registration candidate lock rhythm pattern data creating portion 54 obtains a registration candidate lock rhythm data supplied from the registration candidate lock rhythm data obtaining portion 53, creates lock rhythm pattern data being a candidate for registration (which will be called registration candidate lock rhythm pattern data) based on the obtained registration candidate lock rhythm data, and supplies the created registration candidate lock rhythm pattern data to a lock rhythm pattern setting portion 55.

The lock rhythm pattern setting portion 55 obtains the registration candidate lock rhythm pattern data supplied from the registration candidate lock rhythm pattern data creating portion 54, defines a lock rhythm pattern for locking or unlocking based on the obtained registration candidate lock rhythm pattern data, and supplies the lock rhythm pattern data, which is data on the defined lock rhythm pattern, to the auxiliary memory portion 56.

The auxiliary memory portion 56 includes the memory portion 47 in FIG. 6 and obtains the lock number data supplied from the lock number setting portion 52 and stores the obtained lock number data. The auxiliary memory portion 56 further obtains the lock rhythm pattern supplied from the lock rhythm pattern data setting portion 55 and stores the obtained lock rhythm pattern data. The auxiliary memory portion 56 preliminarily stores data required for driving the components of the digital cellular phone 2.

A lock number input data obtaining portion 57 obtains, through the operation input control portion 33, input data of a lock number (which will be called lock number input data, hereinafter) for canceling the lock input by a user by operating the operation keys 16 and supplies the obtained lock number input data to a lock number authenticating portion 58.

The lock number authenticating portion 58 obtains the lock number input data supplied from the lock number input data obtaining portion 57, read out the lock number data stored in the auxiliary memory portion 56, and authenticates an input lock number based on the obtained lock number input data by using the lock number based on the read lock number data. If it is determined, as a result of the authentication, that the input lock number based on the obtained lock number input data agrees with the lock number based on the lock number data stored in the auxiliary memory portion 56, the lock number authenticating portion 58 generates an authentication-agreed instruction signal indicating the agreement of the input lock number based on the obtained lock number input data and supplies the generated authentication-agreed instruction signal to a locking/unlocking control portion 62.

On the other hand, if it is determined, as a result of the authentication, that the input lock number based on the obtained lock number input data does not agree with the lock number based on the lock number data stored in the auxiliary memory portion 56, the lock number authenticating portion 58 generates an authentication-disagreed instruction signal indicating the disagreement of the lock number input based on the obtained lock number input data and supplies the generated authentication-disagreed instruction signal to the LCD control portion 36.

A lock rhythm input data obtaining portion 59 obtains, through the operation input control portion 33, input data on a lock rhythm (which will be called lock rhythm input data) for canceling the lock input by a user by operating the operation keys 16 and supplies the obtained lock rhythm input data to a lock rhythm pattern input data creating portion 60.

The lock rhythm pattern input data creating portion 60 obtains the lock rhythm input data supplied from the lock rhythm input data obtaining portion 59, creates lock rhythm pattern input data for unlocking based on the obtained lock rhythm input data and supplies the created lock rhythm pattern input data to a lock rhythm pattern authenticating portion 61.

The lock rhythm pattern authenticating portion 61 obtains the lock rhythm pattern input data supplied from the lock rhythm pattern input data creating portion 60, reads out the lock rhythm pattern data stored in the auxiliary memory portion 56, and authenticates the input lock rhythm pattern based on the obtained lock rhythm pattern input data by using the lock rhythm pattern based on the read lock rhythm pattern data. If it is determined, as a result of the authentication, that the input lock rhythm pattern based on the obtained lock rhythm pattern input data agrees with the lock rhythm pattern based on the lock rhythm pattern data stored in the auxiliary memory portion 56, the lock rhythm pattern authenticating portion 61 generates an authentication-agreed instruction signal indicating the agreement of the lock rhythm pattern based on the obtained lock rhythm pattern input data and supplies the generated authentication-agreed instruction signal to the locking/unlocking control portion 62.

On the other hand, if it is determined, as a result of the authentication, that the input lock rhythm pattern based on the obtained lock rhythm pattern input data disagrees with the lock rhythm pattern based on the lock rhythm pattern data stored in the auxiliary memory portion 56, the lock rhythm pattern authenticating portion 61 generates an authentication-disagreed instruction signal indicating the disagreement of the lock rhythm pattern input based on the obtained lock rhythm pattern input data and supplies the generated authentication-disagreed instruction signal to the LCD control portion 36.

The locking/unlocking control portion 62 recognizes, based on the authentication-agreed instruction signal supplied from the lock number authenticating portion 58, the agreement of the input lock number based on the obtained lock number input data and controls locking/or unlocking (including temporary unlocking) of the digital cellular phone 2.

A state determining portion 63 determines the current state of the digital cellular phone 2 based on a detection signal output from the magnetic sensors 20a to 20d. In other words, the state determining portion 63 determines one of the first to fifth states (five states) shown in FIGS. 1A to 5B. If the current state of the digital cellular phone 2 is determined as the fifth state, the state determining portion 63 generates a state detection instruction signal indicating the result of the state detection of the digital cellular phone 2 and supplies the generated state detection instruction signal to a switching control portion (second control unit) 64.

The switching control portion 64 recognizes the current state of the digital cellular phone 2 based on the state detection instruction signal supplied from the state determining portion 63, generates a switching control signal for controlling the switching to the input screen for inputting a lock number and/or lock rhythm pattern for locking or unlocking, and supplies the generated switching control signal to the LCD control portion 36. The switching control portion 64 recognizes whether the numeral key or keys of the operation keys 16 or the side key 19 has/have been pressed by a user or not under the control of the operation input control portion 33, generates a switching control signal for controlling switching to the input screen for inputting a lock number and/or lock rhythm pattern for locking or unlocking, and supplies the generated switching control signal to the LCD control portion 36.

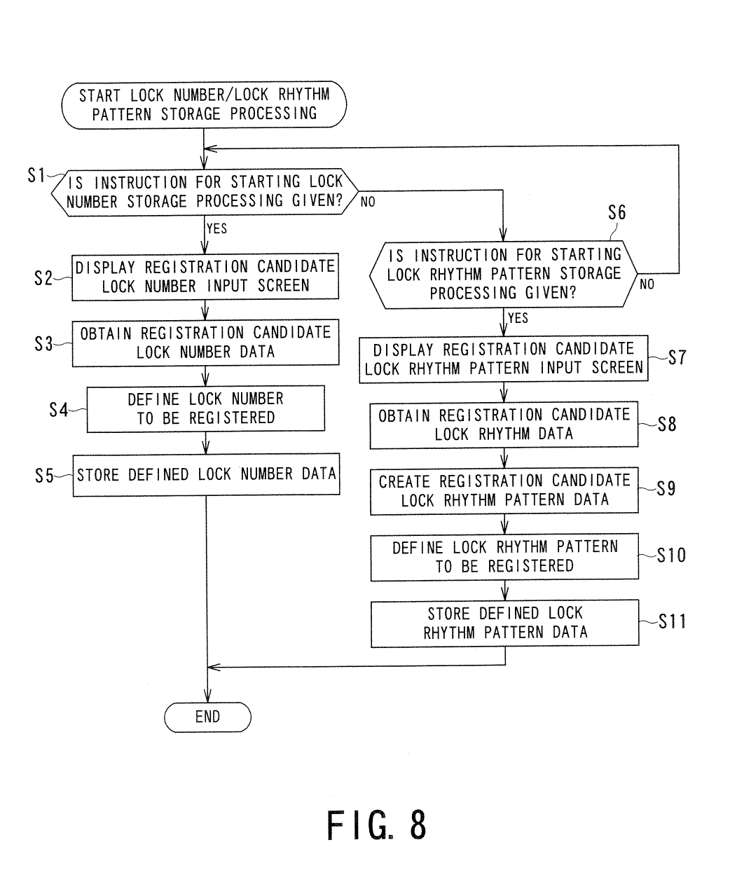

Referring to the flowchart in FIG. 8, lock number/lock rhythm pattern storage processing in the digital cellular phone 2 in FIG. 7 will be described hereunder.

In step S1, the operation input control portion 33 determines whether an instruction has been given for starting lock number storage processing by a user by operating the operation keys 16 or not.

If it is determined in step S1 that the instruction has been given for starting the lock number storage processing by a user by operating the operation keys 16, the LCD control portion 36 causes the liquid crystal display 14 to display a registration candidate lock number input screen in step S2. The liquid crystal display 14 displays the registration candidate lock number input screen under the control of the LCD control portion 36.

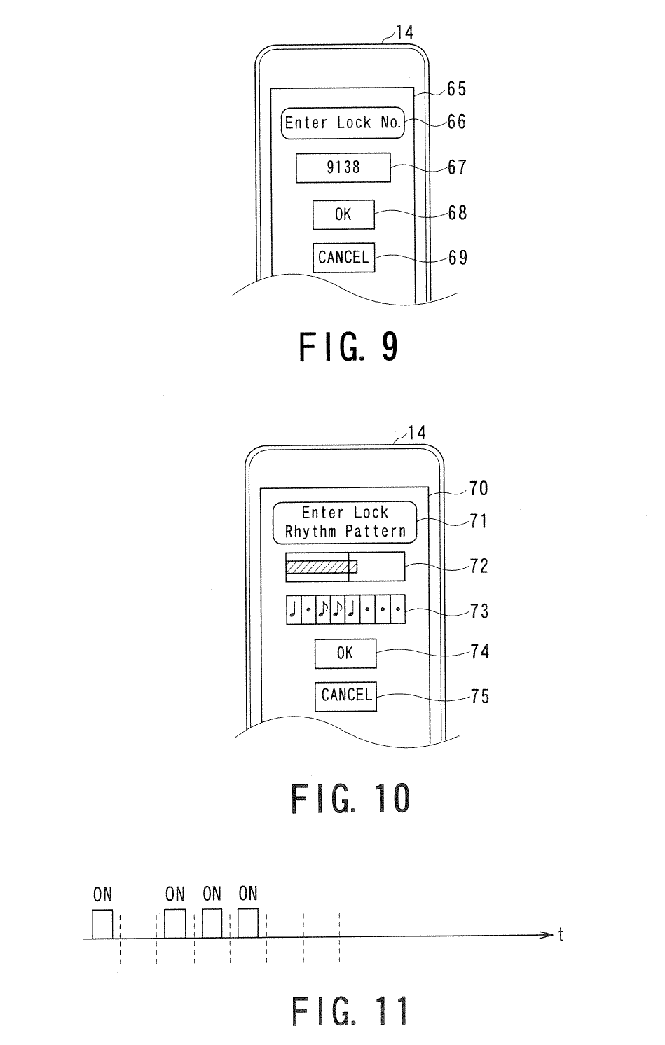

FIG. 9 shows a display example of the registration candidate lock number input screen 65 to be displayed on the liquid crystal display 14 in FIG. 6.

The registration candidate lock number input screen 65 in FIG. 9 has a message display field 66, an input receiving field 67 for receiving the input of a lock number being a candidate for registration, and command display fields 68 and 69 for displaying commands.

In the example in FIG. 9, the message display field 66 displays “Enter Lock No.” as a message. Thus, a user can input a lock number being a candidate for registration and can register the lock number by following processes.

The input receiving field 67 is a field for receiving the input of a lock number being a candidate for registration by operating a numeral key or keys, for example, of the operation keys 16 by a user. In the example in FIG. 9, the input of the number, for example, “9138”, is received as a registration candidate lock number, for example. The input numeral/numerals is/are not limited to be displayed as it is but may be displayed by a symbol “*” so as to prevent the display of the lock number.

The command display fields 68 and 69 have icons of commands, “OK” and “CANCEL”, respectively. A user can select the command icon, “OK”, in the command display field 68 by operating the operation keys 16 to instruct the registration of the registration candidate lock number. A user can select the command icon, “CANCEL” in the command display field 69 by operating the operation keys 16 to cancel the registration processing on the registration candidate lock number.

The operation input control portion 33 determines whether the registration of the registration candidate lock number has been instructed or not based on the selection by a user of the “OK” icon in the command display field 68 by operating the operation keys 16 on the registration candidate lock number input screen in FIG. 9.

If the “OK” icon in the command display field 68 is selected by a user by operating the operation keys 16, the operation input control portion 33 determines that the registration of the registration candidate lock number has been instructed based on the selection by a user of the “OK” icon in the command display field 68 by operating the operation keys 16.

On the other hand, if the “CANCEL” icon in the command display field 69 is selected by a user by operating the operation keys 16, the operation input control portion 33 determines that the registration of the registration candidate lock number has been cancelled based on the selection by a user of the “CANCEL” icon in the command display field 69 by operating the operation keys 16.

In step S3, the registration candidate lock number data obtaining portion 51 obtains through the operation input control portion 33 the registration candidate lock number data input by a user by operating the operation keys 16 and supplies the obtained registration candidate lock number data to the lock number setting portion 52.

In the example in FIG. 9, the input receiving field 67 is receiving the input of “9138” as a registration candidate lock number, and the registration candidate lock number data obtained by the registration candidate lock number data obtaining portion 51 includes data on the input registration candidate lock number, “9138”.

In step S4, the lock number setting portion 52 obtains the registration candidate lock number data supplied from the registration candidate lock number data obtaining portion 51, defines the lock number for locking/unlocking based on the obtained registration candidate lock number data and supplies the lock number data, which is data on the defined lock number, in the auxiliary memory portion 56.

In the example in FIG. 9, the lock number for locking or unlocking is set to “9138”, for example. Thus, a user can lock or unlock by inputting “9138” as the lock number.

In step S5, the auxiliary memory portion 56 obtains the lock number data supplied from the lock number setting portion 52 and stores the obtained lock number data. Thus, the lock number for locking or unlocking can be stored.

Then, the lock number/lock rhythm pattern storage processing ends.

On the other hand, if it is determined in step S1 that the starting of the lock number storage processing has been instructed by a user by operating the operation keys 16, the operation input portion 33 determines in step S6 whether starting the lock rhythm pattern storage processing has been instructed or not.

If it is determined in step S6 that the starting of the lock rhythm pattern storage processing has not been instructed, the processing returns to step S1, and the processing in step S1 and subsequent steps are repeated.

If it is determined in step S6 that the starting of the lock rhythm pattern storage processing has been instructed, the LCD control portion 36 in step S7 causes the liquid crystal display 14 to display the registration candidate lock rhythm pattern input screen. The liquid crystal display 14 displays the registration candidate lock rhythm pattern input screen under the control of the LCD control portion 36.

FIG. 10 shows a display example of a registration candidate lock rhythm pattern input screen 70 displayed on the liquid crystal display 14 in FIG. 6.

The registration candidate lock rhythm pattern input screen 70 in FIG. 10 has a message display field 71, a time bar display field 72, an input receiving screen 73 for receiving the input of a lock rhythm pattern being a candidate for registration, and command fields 74 and 75 for displaying commands.

In the example in FIG. 10, the message display field 71 displays “Enter Lock Rhythm Pattern” as a message. Thus, a user can input a lock rhythm pattern being a candidate for registration and can register the lock rhythm pattern by following processes.

The time bar display field 72 is a display field for displaying a time bar indicating timing for receiving the input of a lock rhythm being a candidate for registration. The time bar displayed in the time bar display field 72 makes left-to-right transition with the passage of time.

The input receiving field 73 is a field for receiving the input of a lock rhythm pattern being a candidate for registration by operating a confirmation key, for example, of the operation keys 16 by a user. In the example in FIG. 10, the input of “quarter note/eighth note, eighth note, quarter note/// (tap/tata/tap///, where “/” indicates a rest)” is received as a registration candidate lock rhythm pattern, for example. The registration candidate lock rhythm pattern may be any rhythm pattern that a user can memorize.

The command display fields 74 and 75 have icons of commands, “OK” and “CANCEL”, respectively. A user can select the command icon, “OK”, in the command display field 74 by operating the operation keys 16 to instruct the registration of the registration candidate lock rhythm pattern. A user can select the command icon, “CANCEL” in the command display field 75 by operating the operation keys 16 to cancel the registration processing on the registration candidate lock rhythm pattern.

The operation input control portion 33 determines whether the registration of the registration candidate lock rhythm pattern has been instructed or not based on the selection by a user of the “OK” icon in the command display field 74 by operating the operation keys 16 on the registration candidate lock rhythm pattern input screen in FIG. 10.

If the “OK” icon in the command display field 74 is selected by a user by operating the operation keys 16, the operation input control portion 33 determines that the registration of the registration candidate lock rhythm pattern has been instructed based on the selection by a user of the “OK” icon in the command display field 74 by operating the operation keys 16.

On the other hand, if the “CANCEL” icon in the command display field 75 is selected by a user by operating the operation keys 16, the operation input control portion 33 determines that the registration of the registration candidate lock rhythm pattern has been cancelled based on the selection by a user of the “CANCEL” icon in the command display field 75 by operating the operation keys 16.

In step S8, the registration candidate lock rhythm data obtaining portion 53 obtains through the operation input control portion 33 the registration candidate lock rhythm data input by a user by operating the operation keys 16, and supplies the obtained registration candidate lock rhythm data to the registration candidate lock rhythm pattern data creating portion 54.

In the example in FIG. 10, the registration candidate lock rhythm pattern input to the input receiving field 73 is “quarter note/eighth note, eighth note, quarter note/// (tap/tata/tap///)”, and the registration candidate lock rhythm data obtaining portion 53 obtains registration candidate rhythm data of a timing chart as shown in FIG. 11 from the input registration candidate lock rhythm pattern, “quarter note/eighth note, eighth note, quarter note/// (tap/tata/tap///)”.

In step S9, the registration candidate lock rhythm pattern data creating portion 54 obtains the registration candidate lock rhythm data supplied from the registration candidate lock rhythm data obtaining portion 53, creates the registration candidate lock rhythm pattern data based on the obtained registration candidate lock rhythm data, and supplies the created registration candidate lock rhythm pattern data to the lock rhythm pattern setting portion 55.

In the example in FIG. 10, the registration candidate lock rhythm pattern data creating portion 54 creates registration candidate lock rhythm pattern data represented by “quarter note/eighth note, eighth note, quarter note/// (tap/tata/tap///)” based on the registration candidate lock rhythm data of the timing chart as shown in FIG. 11.

In step S10, the lock rhythm pattern setting portion 55 obtains the registration candidate lock rhythm pattern data supplied from the registration candidate lock rhythm pattern data creating portion 54, defines the lock rhythm pattern for locking or unlocking based on the obtained registration candidate lock rhythm pattern data, and supplies the lock rhythm pattern data, which is data on the defined lock rhythm pattern, to the auxiliary memory portion 56.

In step S11, the auxiliary memory portion 56 obtains the lock rhythm pattern data supplied from the lock rhythm pattern setting portion 55 and stores the obtained lock rhythm pattern data. Thus, the lock rhythm pattern for locking or unlocking can be stored. Then, the lock number/lock rhythm pattern storage processing ends.

According to an embodiment of the present invention mentioned above, the lock number/lock rhythm pattern storage processing, which has been described with reference to the flowchart in FIG. 8, preliminarily stores both the lock number and lock rhythm pattern to be used for locking or unlocking. In the examples shown in FIGS. 9 and 10, another lock number and lock rhythm pattern may be allowed to store if the lock number and lock rhythm pattern registered before are input and agreed.

Next, automatic lock setting processing will be described for setting by using a lock number or lock rhythm pattern. Three functions, “automatic lock/ON”, “automatic lock/OFF” and “automatic lock/ON (with re-locking)”, are provided and will be defined below. However, they are only examples and may be applicable to other lock settings and unlocking.

The “automatic lock/ON” means the limitation of the operation on the functions of the digital cellular phone 2 and limitation of manipulations for operations excluding operations for response/denial if called, adjustment of the volume when called, and stop of an alarm sound. The “automatic lock/ON” allows the temporary cancellation of the automatic lock state by inputting a lock number or inputting a lock rhythm pattern. Then, operations are limited every time power is turned off and is then turned on again.

The “automatic lock/OFF” means the state that the automatic lock state is completely cancelled. The “automatic lock/ON (with re-locking)” is the same as the “automatic lock/ON” in that the operations on the functions of the digital cellular phone 2 are limited but means that operations are limited again when no manipulations are performed on a standby screen by a user for a predetermined period of time after the automatic lock state is temporarily cancelled by input of a lock number or input of a lock rhythm pattern.

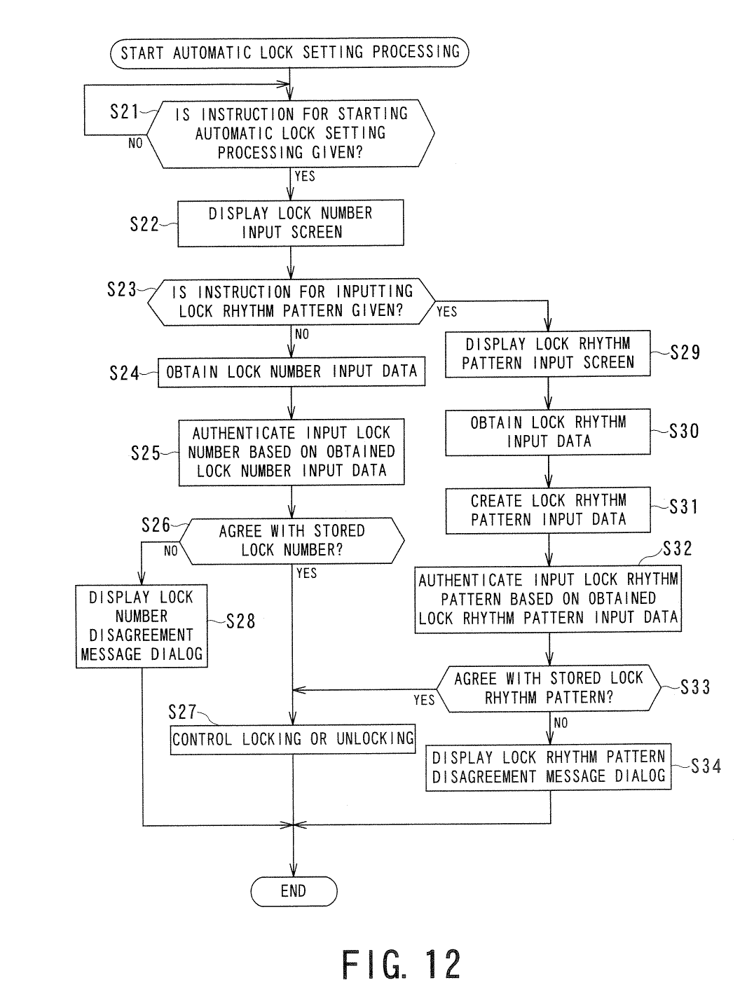

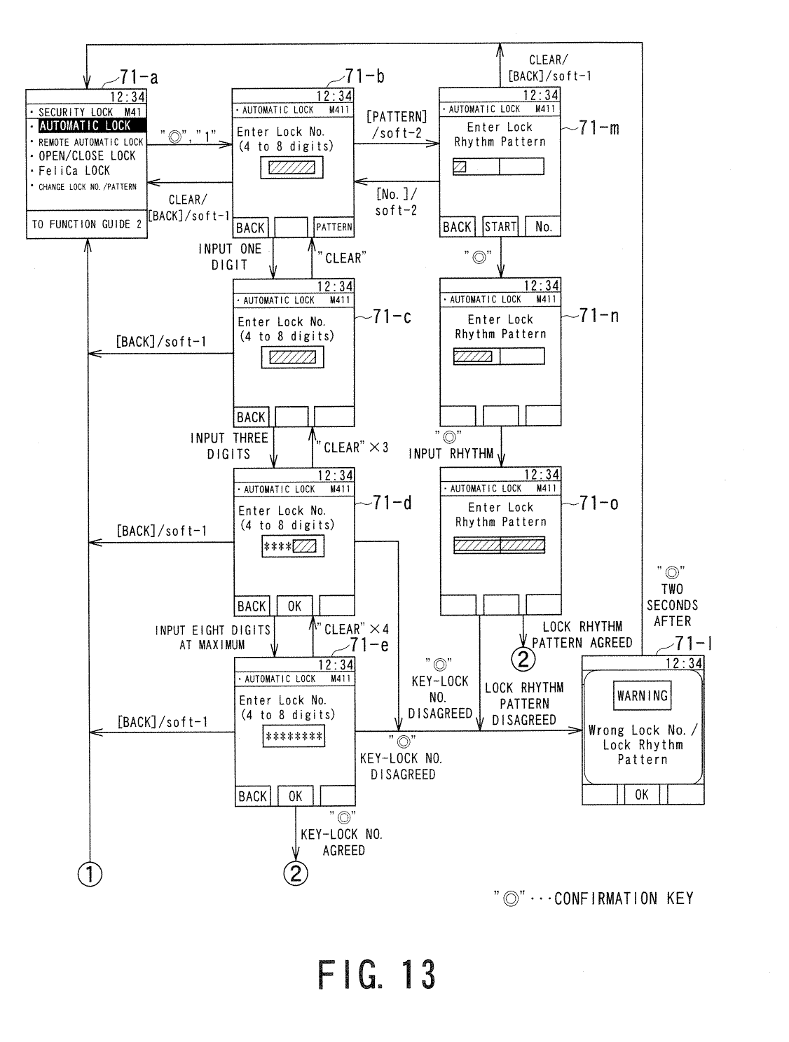

Referring to the flowchart in FIG. 12, the automatic lock setting processing in the digital cellular phone 2 in FIG. 7 will be described. Before performing the automatic lock setting processing, a lock menu screen 71-a in FIG. 13 is displayed on the liquid crystal display 14, and the automatic lock setting processing is started in response to the selection by a user of “Automatic lock” on the lock menu screen 71-a by operating the operation keys 16. FIG. 13 shows a transition of display screens to be displayed on the liquid crystal display 14 in the automatic lock setting processing.

In step S21, the operation input control portion 33 determines whether an instruction for starting the automatic lock setting processing has been given or not and waits until the instruction for starting the automatic lock setting processing is given.

In step S21, if it is determined that the instruction for starting the automatic lock setting processing has been given, the operation input control portion 33 notifies the LCD control portion 36 that the instruction for starting the automatic lock setting processing has been given.

In step S22, the LCD control portion 36 in accordance with the notification from the operation input control portion 33 causes the liquid crystal display 14 to display a lock number input screen. Under the control of the LCD control portion 36, the liquid crystal display 14 displays a lock number input screen 71-b in FIG. 13. Then, when “BACK” on the lock number input screen 71-b is selected by manipulating the clear key of the operation keys 16 by a user or by manipulating the soft-1 key (electronic mail key) of the operation keys 16 by a user, the automatic lock setting processing is cleared and the liquid crystal display 14 displays the lock menu screen 71-a again.

In step S23, the operation input control portion 33 determines that an instruction for inputting a lock rhythm pattern has been given or not based on the selection of “Pattern” on the lock number input screen 71-b in FIG. 13 by manipulating the soft-2 key (browser key) of the operation keys 16 by a user.

If it is determined in step S23 that the instruction for inputting a lock rhythm pattern has not been given, the lock number input data obtaining portion 57 in step S24 obtains through the operation input control portion 33 lock number input data for canceling the input lock by manipulating the operation keys 16 by a user and supplies the obtained lock number input data to the lock number authenticating portion 58.

As shown on the lock number input screen 71-c in FIG. 13, one digit of a lock number is first input by manipulating a numeral key, for example, of the operation keys 16 by a user. If a user desires the clearing of the input of the one digit, the input of the one digit can be cleared by manipulating the clear key of the operation keys 16 by a user, and the lock number input screen 71-b in FIG. 13 is displayed again. If “BACK” on the lock number input screen 71-c is selected by manipulating the soft-1 key of the operation keys 16 by a user, the automatic lock setting processing is cleared, and the lock menu screen 71-a is displayed again.

Next, as shown on the lock number input screen 71-d in FIG. 13, three digits of the lock number are input by manipulating a numeral key or keys of the operation keys 16 by a user. If the user desires the clearing of the input of the three digits, the input of three digits can be cleared by manipulating the clear key of the operation keys 16 by the user. Then, the lock number input screen 71-c in FIG. 13 is displayed again. If “BACK” on the lock number input screen 71-d is selected by manipulating the soft-1 key of the operation keys 16 by a user, the automatic lock setting processing is cleared, and the lock menu screen 71-a is displayed again.

As shown on the lock number input screen 71-e in FIG. 13, four digits of the lock number are input by manipulating a numeral key or keys of the operation keys 16 by a user. If a user desires the clearing of the input of the four digits, the input of the four digits can be cleared by manipulating the clear key of the operation keys 16 by the user. Then, the lock number input screen 71-d in FIG. 13 is displayed again. If “BACK” on the lock number input screen 71-e is selected by manipulating the soft-1 key of the operation keys 16, the automatic lock setting processing is cleared, and the lock menu screen 71-a is displayed again.

In step S25, the lock number authenticating portion 58 obtains the lock number input data supplied from the lock number input data obtaining portion 57, reads out lock number data stored in the auxiliary memory portion 56 and authenticates the input lock number based on the obtained lock number input data by using the lock number based on the read lock number data.

If it is determined in step S26 that the input lock number based on the obtained lock number input data agrees with the lock number based on the lock number data stored in the auxiliary memory portion 56, the lock number authenticating portion 58 generates an authentication-agreed instruction signal indicating the agreement of the input lock number based on the obtained lock number input data and supplies the generated authentication-agreed instruction signal to the locking/unlocking control portion 62.

In step S27, the locking/unlocking control portion 62 recognizes, based on the authentication-agreed instruction signal supplied from the lock number authenticating portion 58, that the input lock number based on the obtained lock number input data has agreed and controls the locking or unlocking of the digital cellular phone 2.

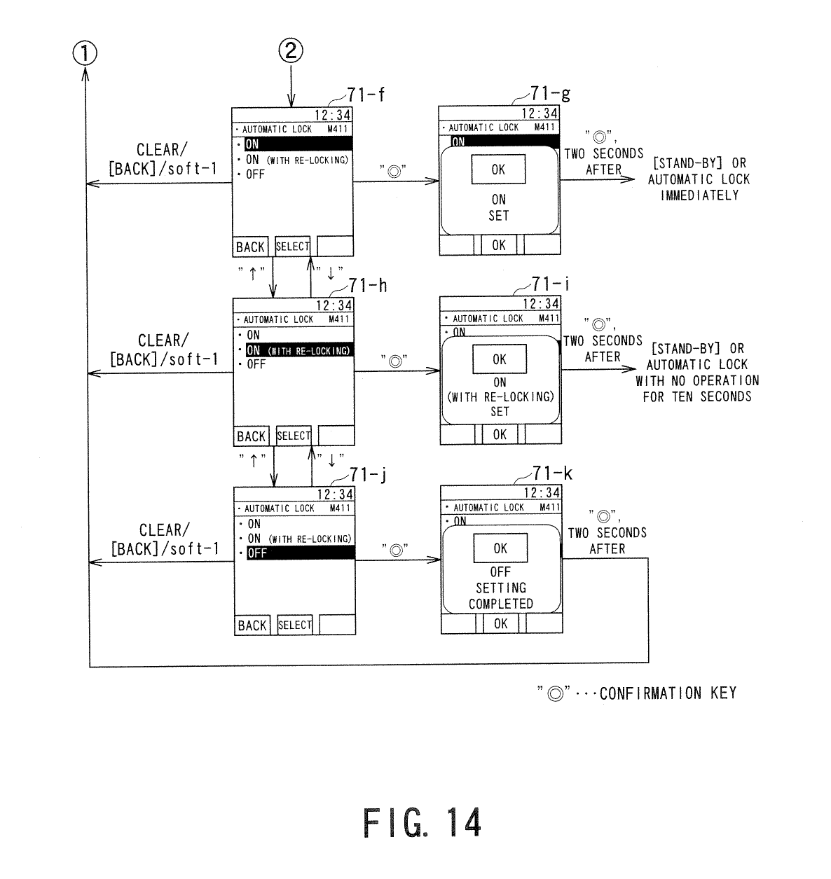

Here, the LCD control portion 36 causes the liquid crystal display 14 to display an automatic lock execution screen 71-f in FIG. 14. The liquid crystal display 14 displays the automatic lock execution screen 71-f in FIG. 14 under the control of the LCD control portion 36. Next, if the confirmation key, for example, of the operation keys 16 is manipulated by a user, an automatic lock setting completion screen 71-g in FIG. 14 is displayed on the liquid crystal display 14. If a user manipulates the clear key of the operation keys 16 or if the user manipulates the soft-1 key of the operation keys 16 to select “BACK” on the automatic lock setting completion screen 71-f, the automatic lock setting processing is cleared, and the lock menu screen 71-a is displayed again.

If the cross key, for example, of the operation keys 16 on the automatic lock execution screen 71-f in FIG. 14 is manipulated by a user, an automatic lock execution screen 71-h in FIG. 14 is displayed on the liquid crystal display 14. Next, if the confirmation key, for example, of the operation keys 16 is manipulated by a user, an automatic lock/ON (with re-locking) setting completion screen 71-i in FIG. 14 is displayed on the liquid crystal display 14. If a user manipulates the clear key of the operation keys 16 or if the user manipulates the soft-1 key of the operation keys 16 to select “BACK” on the automatic lock setting completion screen 71-f, the automatic lock setting processing is cleared, and the lock menu screen 71-a is displayed again.

Then, if the confirmation key, for example, of the operation keys 16 is further manipulated by a user after the automatic lock setting completion screen 71-g in FIG. 14 is displayed, the “automatic lock/ON” function is executed after a predetermined period of time (for example, after two seconds), and a stand-by screen is displayed on the liquid crystal display 14.

If the confirmation key, for example, of the operation keys 16 is further manipulated by a user after the “automatic lock/ON (with re-locking)” setting completion screen 71-i in FIG. 14 is displayed, the “automatic lock/ON (with re-locking)” is executed after a predetermined period of time (for example, after two seconds), and a stand-by screen is displayed on the liquid crystal display 14.

If the cross key, for example, of the operation keys 16 on the automatic lock execution screen 71-h in FIG. 14 is manipulated by a user, an automatic lock execution screen 71-j in FIG. 14 is displayed on the liquid crystal display 14. Next, if the confirmation key, for example, of the operation keys 16 is manipulated by a user, an automatic lock/OFF setting completion screen 71-k in FIG. 14 is displayed on the liquid crystal display 14. If the confirmation key, for example, of the operation keys 16 is further manipulated by a user after that, the automatic lock OFF setting processing is executed after a predetermined period of time (for example, after two seconds), and the lock menu screen 71-a is displayed again.

If a user manipulates the clear key of the operation keys 16 or if the user manipulates the soft-1 key of the operation keys 16 to select “BACK” on the automatic lock setting completion screen 71-j, the automatic lock setting processing is cleared, and the lock menu screen 71-a is displayed again.

On the other hand, if it is determined in step S26 that the input lock number based on the obtained lock number input data disagrees with the lock number based on the lock number data stored in the auxiliary memory portion 56, the lock number authenticating portion 58 generates an authentication-disagreed instruction signal indicating the disagreement of the input lock number based on the obtained lock number input data, and supplies the generated authentication-disagreed instruction signal to the LCD control portion 36.

In step S28, the LCD control portion 36 causes the liquid crystal display 14 to display a lock number-disagreed message dialog 71-l in FIG. 13 based on the authentication-disagreed instruction signal supplied from the lock number authenticating portion 58. The liquid crystal display 14 displays the lock number-disagreed message dialog 71-l in FIG. 13 under the control of the LCD control portion 36.

The lock number-disagreed message dialog 71-l in FIG. 13 displays a message, “Wrong Lock No.” Thus, a user can be informed that his/her input lock number is wrong.

Then, if the confirmation key, for example, of the operation keys 16 is manipulated by a user, the lock menu screen 71-a in FIG. 13 is displayed, and the automatic lock setting processing ends.

On the other hand, if it is determined in step S23 that the instruction for inputting a lock rhythm pattern has been given, the LCD control portion 36 causes the liquid crystal display 14 to display a lock rhythm pattern input screen in step S29 in response to the notification from the operation input control portion 33. The liquid crystal display 14 displays a lock rhythm pattern input screen 71-m in FIG. 13 under the control of the LCD control portion 36.

The lock rhythm pattern input screen 71-m in FIG. 13 displays an input field for inputting a lock rhythm pattern. As shown on the lock number input screens 71-n and 71-o in FIG. 13, a lock rhythm pattern is input by manipulating the confirmation key, for example, of the operation keys 16 by a user.

If “No” is selected on the lock rhythm pattern input screen 71-m by manipulating the soft-2 key (browser key) of the operation keys 16 by a user, the lock number input screen 71-b is displayed again. On the other hand, “BACK” is selected on the lock rhythm pattern input screen 71-m by manipulating the soft-1 key (electronic mail key) of the operation keys 16 by a user, the lock menu screen 71-a is displayed again. Then, the automatic lock setting processing ends.

In step S30, the lock rhythm input data obtaining portion 59 obtains through the operation input control portion 33 lock rhythm input data for canceling the lock input by manipulating the confirmation key of the operation keys 16 by a user and supplies the obtained lock rhythm input data to the lock rhythm pattern creating portion 60.

In step S31, the lock rhythm pattern input data creating portion 60 obtains the lock rhythm input data supplied from the lock rhythm input data obtaining portion 59, creates lock rhythm pattern input data for canceling the lock based on the obtained lock rhythm input data, and supplies the created lock rhythm pattern input data to the lock rhythm pattern authenticating portion 61.

In step S32, the lock rhythm pattern authenticating portion 61 obtains the lock rhythm pattern input data from the lock rhythm pattern input data creating portion 60, reads out the lock rhythm pattern data stored in the auxiliary memory portion 56, and authenticates the input lock rhythm pattern based on the obtained lock rhythm pattern input data by using the lock rhythm pattern based on the read lock rhythm pattern data.

If it is determined that the input lock rhythm pattern based on the lock rhythm pattern input data obtained in step S33 agrees with the lock rhythm pattern based on the lock rhythm pattern data stored in the auxiliary memory portion 56, the lock rhythm pattern authenticating portion 61 generates an authentication-agreed instruction signal indicating the disagreement of the input lock rhythm pattern based on the obtained lock rhythm pattern input data, and supplies the created authentication-agreed instruction signal to the locking/unlocking control portion 62.

Then, the processing moves to step S27, and the processings in step S27 and subsequent steps are repeated.

On the other hand, if it is determined in step S33 that the input lock rhythm pattern based on the obtained lock rhythm pattern input data does not agree with the lock rhythm pattern based on the lock rhythm pattern data stored in the auxiliary memory portion 56, an authentication-disagreed instruction signal indicating the disagreement of the input lock rhythm pattern based on the obtained lock rhythm pattern input data is generated, and the generated authentication-disagreed instruction signal is supplied to the LCD control portion 36.

In step S34, the LCD control portion 36 causes the liquid crystal display 14 to display the lock rhythm pattern-disagreed message dialog 71-l in FIG. 13 based on the authentication-disagreed instruction signal supplied from the lock rhythm pattern authenticating portion 61. The liquid crystal display 14 displays the lock rhythm pattern-disagreed message dialog 71-l in FIG. 13 under the control of the LCD control portion 36.

The lock rhythm pattern-disagreed message dialog 71-l in FIG. 13 displays a message of “Wrong Lock Rhythm Pattern”. Thus, a user can be informed that his/her input lock rhythm pattern is wrong.

Then, if the confirmation key, for example, of the operation keys 16 is manipulated by a user, the lock menu screen 71-a in FIG. 13 is displayed after a predetermined period of time, for example, after two seconds, and the automatic lock setting processing ends.

Further, the lock number data and lock rhythm pattern data, for example, in the embodiments of the present invention are defined as “authentication information” and are defined as “first authentication information” and “second authentication information”, respectively. The input screen for inputting the authentication information is defined as “authentication information input screen”.

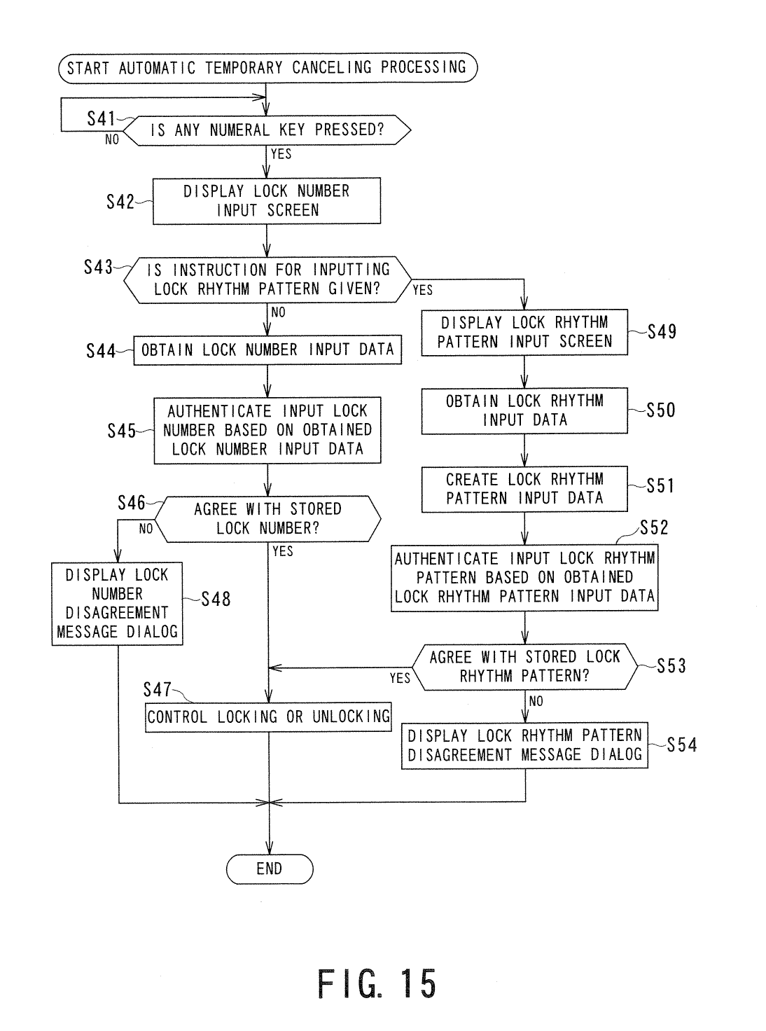

Next, referring to the flowchart of FIG. 15, the processing of temporary canceling automatic locking will be described. The processing in steps S44 to S54 in FIG. 15 is basically the same as the processing in steps S24 to S34 in FIG. 12, and the repetitive description will be omitted herein.

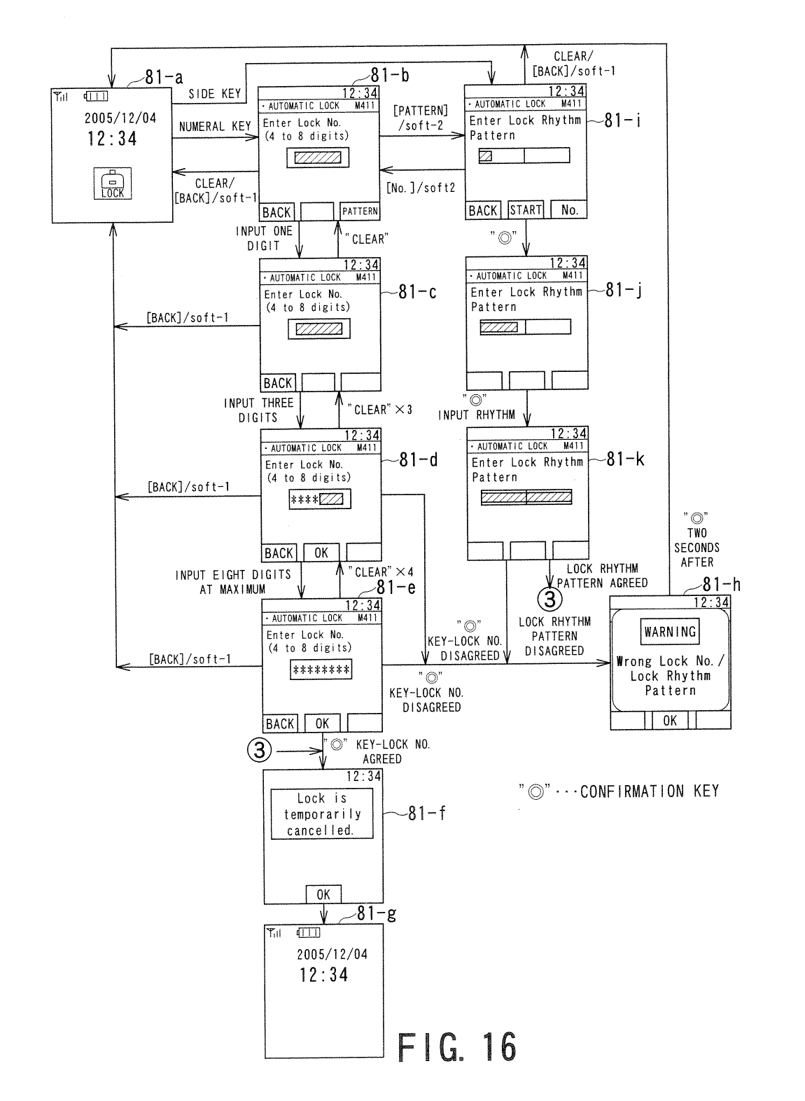

Before performing the automatic lock temporarily canceling processing, a stand-by screen 81-a in FIG. 16 is first displayed on the liquid crystal display 14, and the automatic lock temporarily canceling processing is started by manipulating a numeral key of the operation keys 16 by a user. FIG. 16 shows a transition of display screens to be displayed on the liquid crystal display 14 in the automatic lock temporary canceling processing. Display screens 81-b to 81-e and display screens 81-h to 81-k in FIG. 16 are basically the same as the display screens 71-b to 71-e and display screens 71-l to 71-o in FIG. 13, and the repetitive descriptions will be omitted herein.

In step S41, the operation input control portion 33 determines whether any one numeral key of the operation keys 16 has been pressed by manipulating the operation key or keys 16 by a user or not and waits until the determination that one numeral key of the operation keys 16 has been pressed.

If it is determined in step S41 that one numeral key of the operation keys 16 has been pressed, the operation input control portion 33 notifies the LCD control portion 36 that one numeral key of the operation keys 16 has been pressed.

In step S42, the LCD control portion 36 causes the liquid crystal display 14 to display the lock number input screen in accordance with the notification from the operation input control portion 33. The liquid crystal display 14 displays the lock number input screen 81-b in FIG. 13 under the control of the LCD control portion 36. Then, if a user manipulates the clear key of the operation keys 16 or if the user manipulates the soft-1 key (electronic mail key) of the operation keys 16 by a user to select “BACK” on the lock number input screen 81-b, the automatic lock temporary canceling processing is cleared, and the stand-by screen 81-a is displayed again.

In step S43, the operation input control portion 33 determines whether “Pattern” has been selected on the lock number input screen 81-b in FIG. 16 by manipulating the soft-2 key (browser key) of the operation keys 16 by a user and the instruction for inputting a lock rhythm pattern has been given or not.

If it is determined in step S43 that no instruction for inputting a lock rhythm pattern has been given, the processing moves to step S44. Then, processings in step S44 and subsequent steps are performed. In other words, the automatic lock temporary canceling processing is performed by using a lock number. When the automatic lock temporary canceling is controlled in step S47, the lock temporary canceling completion screen 81-f in FIG. 16 is displayed. Then, if the confirmation key, for example, of the operation keys 16 is further manipulated by a user, the stand-by screen 81-g, which is to be displayed when automatic locking is temporarily cancelled, is displayed again. Further, the stand-by screen 81-g does not display an icon indicating “LOCK” unlike the stand-by screen 81-a.

If it is determined in step S43 that the instruction for inputting a lock rhythm pattern has been given, the LCD control portion 36 in step S49 causes the liquid crystal display 14 to display a lock rhythm pattern input screen in accordance with the notification from the operation input control portion 33. The liquid crystal display 14 displays a lock rhythm pattern input screen 81-i in FIG. 16 under the control of the LCD control portion 36. Then, the processing moves to step S50, and the processings in step S50 and subsequent steps are performed. In other words, the automatic lock temporary canceling processing by using a lock rhythm pattern is performed.

By the way, at the fifth state (that is, the state shown in FIG. 5) that the biaxial rotation style digital cellular phone is folded, a user cannot input a lock number by using a numeral key or keys of the operation keys 16 for locking or unlocking in the automatic lock setting processing in FIG. 12 or in the automatic lock temporary canceling processing in FIG. 15. This is because the operation keys 16 including the numeral keys are covered by the first cabinet 12 of the digital cellular phone 2, and numeral keys cannot be manipulated at the fifth state with the digital cellular phone 2 folded.

Accordingly, authentication information input screens for inputting authentication information for locking or unlocking (such as a lock number input screen for inputting a lock number and a lock rhythm pattern input screen for inputting a lock rhythm pattern) may be switched in accordance with the type of operation key to be pressed by a user (such as the numeral keys or the side key 19 of the operation keys 16) and/or the state of the digital cellular phone 2. The authentication information input screen switching control processing will be described below.

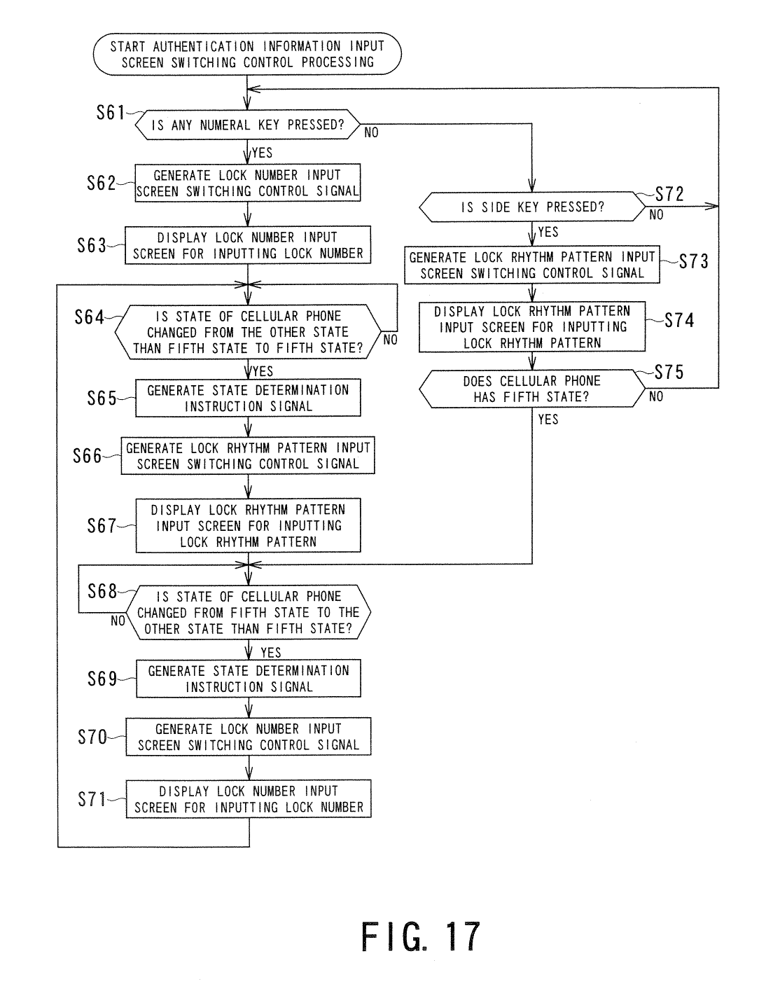

Referring to the flowchart in FIG. 17, the authentication information input screen switching control processing in the digital cellular phone 2 in FIG. 7 will be described. The authentication information input screen switching control processing is performed in parallel with the processing in steps S22, S23 and S29 of the automatic lock setting processing in FIG. 12. More specifically, the authentication information input screen switching control processing is performed among the lock menu screen 71-a, lock number input screen 71-b and lock rhythm pattern input screen 71-m in FIG. 13.

The authentication information input screen switching control processing is also performed in parallel with the processing in steps S41 to S43 and S49 of the automatic lock temporary canceling processing in FIG. 15. More specifically, the authentication information input screen switching control processing is performed among the stand-by screen 81-a, lock number input screen 81-b, and lock rhythm pattern input screen 81-i in FIG. 16.

The automatic lock setting processing in FIG. 12 and the automatic lock temporary canceling processing in FIG. 15 may be started when the digital cellular phone 2 has the first state (the state in FIG. 1) and the fifth state (the state in FIG. 5), for example. First, the case that the digital cellular phone 2 has the first state (the state in FIG. 1) upon start of the authentication information input screen switching control processing will be described then.

In step S61, the operation input control portion 33 determines whether any numeral key of the operation keys 16 has been pressed by manipulating the operation key or keys 16 or not.

If it is determined in step S61 that one numeral key of the operation keys 16 has been pressed by a user, the operation input control portion 33 supplies a switching control portion 64 with the notification that one numeral key of the operation keys 16 has been pressed by manipulating the operation key or keys 16 by a user.

In step S62, the switching control portion 64 recognizes that one numeral key has been pressed by manipulating the operation keys 16 in accordance with the notification from the operation input control portion 33, generates a lock number input screen switching control signal for switching the authentication information input screen for inputting authentication information for locking or unlocking to the lock number input screen for inputting a lock number, and supplies the generated lock number input screen switching control signal to the LCD control portion 36.

In step S63, the LCD control portion 36 causes the liquid crystal display 14 to display the lock number input screen for inputting a lock number based on the lock number input screen switching control signal supplied from the switching control portion 64. The liquid crystal display 14 displays the lock number input screen for inputting a lock number under the control of the LCD control portion 36.

Thus, the lock number input screen for inputting a lock number can be displayed when a user manipulates a numeral key to be used for inputting a lock number of the operation keys 16. Therefore, the authentication information input screens for locking or unlocking can be switched easily, and the operability for locking or unlocking the digital cellular phone 2 in various styles can be improved.

In step S64, the state determining portion 63 determines whether the state of the digital cellular phone 2 has been changed from the other state than the fifth state (that is, one state of the first to fourth state) to the fifth state or not, based on a detection signal output from the magnetic sensors 20a to 20d and waits until the determination that the state of the digital cellular phone 2 in FIG. 5 has been changed from the other state than the fifth state to the fifth state. In other words, the transition in state of the digital cellular phone 2 from the other state than the fifth state to the fifth state can be determined when the digital cellular phone 2 having the first state and displaying the lock number input screen is changed to have the fifth state by a user.

If it is determined in step S64 that the current state of the digital cellular phone 2 has been changed from the other state than the fifth state to the fifth state, the state determining portion 63 in step S65 generates a state detection instruction signal indicating the state detection result for the digital cellular phone 2 (that is, a state instruction signal indicating that the current state of the digital cellular phone 2 has been changed from the other state than the fifth state to the fifth state), and supplies the generated state detection instruction signal to the switching control portion 64.

In step S66, the switching control portion 64 recognizes that the state of the digital cellular phone 2 has been changed from the other state than the fifth state to the fifth state based on the state detection signal supplied from the state determining portion 63, generates a lock rhythm pattern input screen switching control signal for switching the authentication information input screen for inputting authentication information for locking or unlocking to the lock rhythm pattern input screen for inputting a lock rhythm pattern, and supplies the generated lock rhythm pattern input screen switching control signal to the LCD control portion 36.

In step S67, the LCD control portion 36 causes the liquid crystal display 14 to display the lock rhythm pattern input screen for inputting a lock rhythm pattern based on the lock rhythm pattern input screen switching control signal supplied from the switching control portion 64. The liquid crystal display 14 displays the lock rhythm pattern input screen for inputting a lock rhythm pattern under the control of the LCD control portion 36.

Thus, when the state of the digital cellular phone 2 is changed to the state that a lock number cannot be input on the lock number input screen by using a numeral key of the operation keys 16, that is, to the fifth state, the authentication information input screen can be switched to the lock rhythm pattern input screen for inputting a lock rhythm pattern, and the lock rhythm pattern input screen can be displayed. Therefore, in accordance with the change in state of the digital cellular phone 2, the switching to a suitable authentication information input screen can be achieved, and the switching to the authentication information input screen for locking or unlocking can be achieved easily. As a result, the operability for locking or unlocking the digital cellular phone 2 in various styles can be improved.

In step S68, the state determining portion 63 determines, based on the detection signal output from the magnetic sensors 20a to 20d, whether the state of the digital cellular phone 2 is changed from the fifth state to the other state (that is, one state of the first to fourth states) and waits until the determination that the state of the digital cellular phone 2 has been changed from the fifth state to the other state. In other words, the change in state of the digital cellular phone 2 from the fifth state to the other state can be determined when the digital cellular phone 2 having the fifth state and displaying the lock rhythm pattern input screen is changed to have the first state, for example.

If it is determined in step S68 that the current state of the digital cellular phone 2 has been changed from the fifth state to the other state, the state determining portion 63 in step S69 generates a state detection instruction signal indicating the state detection result for the digital cellular phone 2 (that is, the state instruction signal indicating that the current state of the digital cellular phone 2 has been changed from the fifth state to the other state), and supplies the generated state detection instruction signal to the switching control portion 64.

In step S70, the switching control portion 64 recognizes that the state of the digital cellular phone 2 has been changed from the fifth state to the other state based on the state detection signal supplied from the state determining portion 63, generates the lock rhythm number input screen switching control signal for switching the authentication information input screen for inputting authentication information for locking or unlocking to the lock number input screen for inputting a lock number, and supplies the generated lock number input screen switching control signal to the LCD control portion 36.

In step S71, the LCD control portion 36 causes the liquid crystal display 14 to display the lock number input screen for inputting a lock number based on the lock number input screen switching control signal supplied from the switching control portion 64. The liquid crystal display 14 displays the lock number input screen for inputting a lock number under the control of the LCD control portion 36.

Thus, when the state of the digital cellular phone 2 is changed to the state that a lock number can be input on the lock number input screen by using a numeral key of the operation keys 16, that is, to the other state than the fifth state (one state of the first to fourth states), the authentication information input screen can be switched to the lock number input screen for inputting a lock number, and the lock number input screen can be displayed. Therefore, in accordance with the change in state of the digital cellular phone 2, the switching to a suitable authentication information input screen can be achieved, and the switching to the authentication information input screen for locking or unlocking can be achieved easily. As a result, the operability for locking or unlocking the digital cellular phone 2 in various styles can be improved.

After that, the processing moves to step S64, and the processings in step S64 and subsequent steps are repeated.

On the other hand, if it is determined in step S61 that no numeral key of the operation keys 16 has been pressed, the operation input control portion 33 in step S72 determines whether the side key 19 has been pressed by a user or not.

If it is determined in step S72 that the side key 19 has not been pressed by the user, the processing returns to step S61, and the processings in step S61 and subsequent steps are repeated.

If it is determined in step S72 that the side key 19 has been pressed by the user, the operation input control portion 33 supplies the notification that the side key 19 has been pressed by the user to the switching control portion 64.

In step S73, the switching control portion 64 recognizes that the side key 19 has been pressed by a user based on the notification from the operation input control portion 33, generates a lock rhythm pattern input screen switching control signal for switching the authentication information input screen for inputting authentication information for locking or unlocking to the lock rhythm pattern input screen for inputting a lock rhythm pattern, and supplies the generated lock rhythm pattern input screen switching control signal to the LCD control portion 36.

In step S74, the LCD control portion 36 causes the liquid crystal display 14 to display the lock rhythm pattern input screen for inputting a lock rhythm pattern based on the lock rhythm pattern input screen switching control signal supplied from the switching control portion 64. The liquid crystal display 14 displays the lock rhythm pattern input screen for inputting a lock rhythm pattern under the control of the LCD control portion 36.

Thus, even when the state of the digital cellular phone 2 is changed to the state that a lock number can be input on the lock number input screen by using a numeral key of the operation keys 16, that is, to the other state than the fifth state (one state of the first to fourth states), the authentication information input screen can be switched to the lock rhythm pattern input screen for inputting a lock rhythm pattern as preferred by a user if the user operates the side key 19 to be used for inputting a lock rhythm pattern by a user, and the lock rhythm pattern input screen can be displayed. Therefore, the switching to the authentication information input screen for locking or unlocking can be achieved easily, and the operability for locking or unlocking the digital cellular phone 2 in various styles can be improved.

In step S75, the state determining portion 63 determines based on the detection signal output from the magnetic sensors 20a to 20d whether the state of the digital cellular phone 2 is the fifth state or not. In other words, when the digital cellular phone 2 has the first state (the state in FIG. 1) upon the starting of the input screen switching control processing, it is determined that the state of the digital cellular phone 2 is not the fifth state.

If it is determined in step S75 that the state of the digital cellular phone 2 is not the fifth state, the processing returns to step S61, and the processing in step S61 and subsequent steps is repeated. When a numeral key of the operation keys 16 is pressed by a user after that, it is determined that a numeral key has been pressed in step S61. Thus, the lock number input screen in step S63 is displayed on the liquid crystal display 14.

Next, a case that the digital cellular phone 2 has the fifth state (the state in FIG. 5) upon the starting of the input screen switching control processing will be described.

In this case, the operation keys 16 including numeral keys are covered by the first cabinet 12 of the digital cellular phone 2, and a user cannot generally operate the numeral keys at the fifth state and cannot input a lock number on the lock number input screen by using a numeral key of the operation keys 16. Therefore, it is determined in step S61 that no numeral key of the operation keys 16 has been pressed by manipulating the operation keys 16 by a user. The user may press a numeral key of the operation keys 16 at the fifth state when the digital cellular phone 2 has the fifth state upon start of the input screen switching control processing despite of the low operability. In this case, the processing in step S62 and subsequent step may be performed.

If it is determined in step S72 that the side key 19 has been pressed by a user, the lock rhythm pattern input screen for inputting a lock rhythm pattern is displayed on the liquid crystal display 14 in step S74.

Thus, if a user operates the side key 19 to be used for inputting a lock rhythm pattern when a lock number cannot be input on the lock number input screen by using a numeral key of the operation keys 16 in the digital cellular phone 2, that is, when the digital cellular phone 2 has the fifth state, the authentication information input screen can be switched to the lock rhythm pattern input screen for inputting a lock rhythm pattern, and the lock rhythm pattern input screen can be displayed. Therefore, the switching to the authentication information input screen for locking or unlocking can be achieved easily, and the operability for locking or unlocking the digital cellular phone 2 in various styles can be improved.

Thereafter, it is determined in step S75 that the state of the digital cellular phone 2 has the fifth state since the digital cellular phone 2 has the fifth state (the state in FIG. 5) upon the starting of the authentication information input screen switching control processing. Then, the processing moves to step S68.

The state determining portion 63 in step S68 determines based on the detection signal output from the magnetic sensors 20a to 20d whether the state of the digital cellular phone 2 has been changed from the fifth state to the other state (that is, one state of the first to fourth states) and waits until the determination that the state of the digital cellular phone 2 has been changed from the fifth state to the other state.

If it is determined in step S68 that the current state of the digital cellular phone 2 has been changed from the fifth state to the other state, the processing moves to step S69, and then, the processings in step S69 and subsequent steps are repeated.

Thus, when the state of the digital cellular phone 2 is changed to the state that a lock number can be input on the lock number input screen by using a numeral key of the operation keys 16, that is, to the other state (one state of the first to fourth states) than the fifth state, the authentication information input screen can be switched to the lock number input screen for inputting a lock number, and the lock number input screen can be displayed. Therefore, in accordance with the change in state of the digital cellular phone 2, the switching to a suitable authentication information input screen can be achieved, and the switching to the authentication information input screen for locking or unlocking can be achieved easily. As a result, the operability for locking or unlocking the digital cellular phone 2 in various styles can be improved.

The user may use the side key 19, for example, to input a lock rhythm pattern for locking or unlocking using a lock rhythm pattern when the state of the digital cellular phone 2 is the fifth state. Apparently, any one of the operation keys 17a to 17e or an operation key operable by a user when the digital cellular phone 2 has the fifth state may be used instead of the side key 19.

The embodiments of the present invention apply the biaxial rotation style digital cellular phone 2. However, the present invention is not limited thereto but is applicable to the digital cellular phone 2 in various styles that changes in style such as a slide style and a slide-and-rotate stile. Thus, the operability for locking or unlocking the digital cellular phone in various styles can be improved.

The embodiments of the present invention switch and display the authentication information input screens in accordance with the states of the digital cellular phone 2. However, multiple pieces authentication information (such as a lock number and a lock rhythm pattern) may be stored in advance, and the authentication input screens may be switched and displayed by various methods as required in accordance with the states of the digital cellular phone 2. Alternatively, the method to be used may be pre-defined as preferred by a user.

Furthermore, the present invention is applicable to a PDA, a personal computer and other information processing apparatus in addition to a cellular phone.

The series of processing in the embodiments of the present invention may be performed by software and hardware.

The embodiments of the invention illustrate the steps in the flowcharts as examples of the processing to be performed in the described order and in a time-series manner. However, the steps do not have to be always performed in a time-series manner but may be performed in parallel or separately.

What is claimed is:

1. An information processing apparatus comprising:
a memory unit configured to store multiple pieces of authentication information;
an authenticating unit configured to authenticate by using one of the multiple pieces of authentication information stored in the memory unit;
a first control unit configured to control performance of locking or unlocking operation;
a state detecting unit configured to detect a state of the information processing apparatus; and
a second control unit configured to control switching to a screen for inputting the authentication information in accordance with the state detection result detected by the state detecting unit.

2. The information processing apparatus according to claim 1, wherein the second control unit controls the switching to the authentication information input screen in accordance with the state detection result detected by the state detecting unit when the first control unit controls the performance of locking or unlocking.

3. The information processing apparatus according to claim 1, wherein the second control unit controls the authentication information input screen to be switched to a screen for inputting first authentication information when the state detecting unit detects that the information processing apparatus has a state in which the authentication information input screen is exposed outside and a key of multiple keys is covered.

4. The information processing apparatus according to claim 1, wherein the multiple pieces of authentication information include at least first authentication information and second authentication information, the first authentication information being information on a lock number and the second authentication information being information on a lock rhythm pattern.

5. An information processing apparatus comprising:
a memory unit configured to store multiple pieces of authentication information;
an authenticating unit configured to authenticate by using one of the multiple pieces of authentication information stored by the memory unit;
a first control unit configured to control performance of locking or unlocking operation;
a key determining unit configured to determine whether a predetermined key in the information processing apparatus has been pressed or not; and
a second control unit configured to control the switching to a screen for inputting the authentication information when the key determining unit determines that a predetermined key in the information processing apparatus has been pressed.

6. The information processing apparatus according to claim 5, wherein the key determining unit includes a first key determining element for determining whether a first key in the information processing apparatus has been pressed or not, and a second key determining element for determining whether a second key in the information processing apparatus has been pressed or not, and wherein the second control unit controls the authentication information input screen to be switched to a first authentication information input screen for inputting second authentication information.

7. The information processing apparatus according to claim 6, wherein the first key is a numeral key and the second key is a side key.

8. The information processing apparatus according to claim 5, wherein the multiple pieces of authentication information include at least first authentication information and second authentication information, the first authentication information being information on a lock number and the second authentication information being information on a lock rhythm pattern.

9. An information processing apparatus comprising:
a memory unit configured to store multiple pieces of authentication information;
an inputting unit including at least an operation key for inputting the information;
a control unit configured to control performance of locking or unlocking operation;
a state detecting unit configured to detect whether a state of the information processing apparatus is in a first state in which the key is in an operative state and in a second state in which the key is in an inoperative state; and
an authenticating unit configured to authenticate by using one of the multiple pieces of authentication information stored in the memory unit, wherein when the information processing apparatus is in the second state detected by the state detecting unit, the authentication is effected in accordance with information input by an input element other than the above-mentioned operation key.

10. The information processing apparatus according to claim 9, wherein when the information processing apparatus is in the first state detected by the state detecting unit, the authentication is effected in accordance with information input by the above-mentioned operation key.

11. The information processing apparatus according to claim 9, further comprising an image control unit configured to control switching of an image surface for inputting the authentication information in accordance with the state detection result by the state detection unit.

12. The information processing apparatus according to claim 11, which comprises a first cabinet having the image surface and a second cabinet having at least the operation key and wherein the first and second cabinets are overlapped with each other in the second state in which the key is in the inoperative state.

13. The information processing apparatus according to claim 12, wherein in the second state, a surface of the first cabinet on which the image surface is not provided and a surface of the second cabinet on which the key is provided are overlapped with each other.
